(19) United States
(12) Patent Application Publication
(10) Pub. No.: US 2016/0369551 A1
(43) Pub. Date: Dec. 22, 2016

(54) VEHICLE DOOR DRIVE APPARATUS

(71) Applicant: AISIN SEIKI KABUSHIKI KAISHA, Kariya-shi (JP)

(72) Inventors: Shintaro SUZUKI, kariya-shi (JP); Tomokazu SEKI, kariya-shi (JP); Nrio FUKUI, kariya-shi (JP)

(73) Assignee: AISIN SEIKI KABUSHIKI KAISHA, Kariya-shi (JP)

(21) Appl. No.: 14/902,262

(22) PCT Filed: Jun. 20, 2014
(86) PCT No.: PCT/JP2014/003316

§ 371 Date: Dec. 30, 2015

(30) Foreign Application Priority Data
Jul. 4, 2013 (JP) 2013-140863
Jul. 4, 2013 (JP) 2013-140864
Jul. 4, 2013 (JP) 2013-140865

(51) Int. Cl. E05F 15/70; E05F 15/77; E05C 17/00

(52) U.S. Cl. CPC E05F 15/70; E05C 17/00; E05F 15/77; E05Y 2400/45; E05Y 2900/531; E05Y 2400/44; E05Y 2201/716; E05Y 2201/722; E05Y 2400/85; E05Y 2400/86

(57) ABSTRACT

Provided are a vehicle door drive apparatus and a vehicle door drive method capable of decreasing, in a vehicle in which a vehicle door (such as a side door, a back door, and a trunk lid) can manually be opened, an operation force required when the vehicle door is manually opened. According to an embodiment of the present invention, when a command of automatically opening a side door in a fully closed state by a predetermined amount that does not bring the side door into a fully open state is input, a pop-up opening degree θ is determined depending on whether the command is input on a switch on an outer side of a vehicle, or is input on a switch on an inner side thereof. Then, based on the determined opening degree θ, a pop-up open operation is carried out.

### TECHNICAL FIELD

The present invention relates to a vehicle door drive apparatus and a vehicle door drive method, and more particularly, to a vehicle door drive apparatus and a vehicle door drive method capable of controlling an open operation of a door (such as a side door) of a vehicle from a fully closed state (state in which the door is fully closed).

### BACKGROUND ART

Hitherto, in Patent Literature 1, a vehicle door control apparatus configured to improve an operation feeling upon a manual operation of opening/closing a door of a vehicle is proposed. The vehicle door control apparatus disclosed in Patent Literature 1 includes a door drive motor, a lever coupled to a vehicle door, an electromagnetic clutch configured to switch between transmission and disconnection of a drive force of the door drive motor to the lever, and a lever operation unit configured to transmit the drive force to the lever via the electromagnetic clutch. With this configuration, the drive force of the door drive motor is output to a lever drive unit via the electromagnetic clutch as a clutch output depending on an engagement state of the electromagnetic clutch, and the lever drive unit uses the clutch output to protrude/retract the lever so as to open/close the vehicle door. The clutch output changes depending on a gap between two friction plates of the electromagnetic clutch, and the clutch output constitutes a door holding load for the vehicle door.

Moreover, the vehicle door control apparatus further includes a door opening degree sensor configured to detect a position of the vehicle door, and is configured to detect the manual operation on the vehicle door based on an output signal of the door opening degree sensor. In Patent Literature 1, the door position of the vehicle door manually operated is detected, and the door holding load is controlled based on the detection result. In other words, when the user carries out a manual turn operation on the vehicle door, the vehicle door control apparatus detects the manual turn of the vehicle door based on a pulse of a signal input from the door opening degree sensor, and decreases the door holding load. Then, the vehicle door control apparatus decreases the clutch output depending on an operation speed of the vehicle door, or controls the clutch output to have a constant value less than the value obtained when the vehicle door is stopped. Thus, the manual operation on the vehicle door is carried out against the door holding load caused by the clutch output. The control carried out in this way decreases a stuck feeling of the electromagnetic clutch during the manual operation, resulting in an improvement in the operation feeling.

### CITATION LIST

### Patent Literature

Japanese Patent Application Laid-Open No. 2005-280393

### SUMMARY OF INVENTION

### Technical Problem

As apparent from the description given above, for the vehicle in which the vehicle doors can be manually opened/closed, the technology disclosed in Patent Literature 1 has potential of improving the feeling when the vehicle door stopped at an arbitrary angle is manually opened/closed. However, in order to further improve the manual operability of the vehicle door, problems to be solved are still left. Particularly, in the technology disclosed in Patent Literature 1, when the vehicle door is manually opened from a state in which the vehicle door is fully closed (hereinafter referred to as “fully closed state” of the vehicle door), only the control of decreasing the door holding load acting as the door holding force is carried out. Thus, when the user attempts to manually open the vehicle door from the fully closed state, the user is required to operate the vehicle door against at least a weight of the vehicle door itself.

Moreover, according to Patent Literature 1, when the vehicle door is in the fully closed state, the electromagnetic clutch is in a fully engaged state, the output of the clutch is maximum on this occasion, and the door holding load is also maximum. Thus, when the vehicle door is in the fully closed state, and the user manually opens the vehicle door, the user needs to apply a force (operation force) more than the door holding load at the maximum value in addition to the weight of the vehicle door itself. In other words, the user opens the vehicle door while feeling “sense of weight”.

Note that, the force required when the vehicle door is manually opened (force that the user applies to the vehicle door to manually open the vehicle door) is herein referred to as “operation force”.

The present invention has been made in view of the above-mentioned problems, and therefore has an object to provide a vehicle door drive apparatus and a vehicle door drive method capable of decreasing, in a vehicle in which vehicle doors (such as a side door, a back door, and a trunk lid) can manually be opened, the operation force required when the vehicle door is manually opened.

### Solution to Problem

In order to achieve the above-mentioned object, according to a first aspect of the present invention, there is provided a vehicle door drive apparatus, including: an input unit configured to input a command for automatically opening a door of a vehicle in a fully closed state by a predetermined amount that does not bring the door to a fully open state; a door drive unit configured to automatically open the door; a determination unit configured to determine, when the command is input by the input unit, the predetermined amount depending on a state of a user or a state of the vehicle; and an open operation unit configured to control the door drive unit so as to automatically open the door by the determined predetermined amount from the fully closed state.

According to a second aspect of the present invention, there is provided a vehicle door drive apparatus, including: an input unit configured to input a command for automatically opening a door of a vehicle in a fully closed state by a predetermined amount that does not bring the door to a fully open state; a door drive unit configured to automatically open the door; a door holding unit configured to generate a holding force for holding the door to hold the door by the holding force; an open operation unit configured to control, based on the command, the door drive unit so as to automatically open the door by the predetermined amount; and a control unit configured to control generation of the holding force of the door holding unit, and to control, before the door actually starts to move in accordance with the command, the door holding unit so as to enter a state of avoiding the generation of the holding force.

According to a third aspect of the present invention, there is provided a vehicle door drive apparatus, including: a detection unit configured to detect whether or not a vehicle is inclined so that an open direction of a door of the vehicle, which serves as an operation object, is oriented toward a lower side of the vehicle; a door holding unit configured to generate a holding force for holding the door to hold the door by the holding force; and a holding force generation unit configured to control the door holding unit to generate the holding force when the detection unit detects that the vehicle is inclined so that the open direction of the door is oriented toward the lower side of the vehicle.

### Advantageous Effects of Invention

According to the one embodiment of the present invention, when the vehicle door in the fully closed state is opened, the door is automatically opened by the predetermined amount that does not bring the door in the fully open state, and the operation force required to manually open the vehicle door in the fully closed state can thus be decreased. Moreover, depending on the state of the user or the state of the vehicle, or depending on desire of the user (depending on an operation amount by the user for determining the predetermined amount), the predetermined amount is changed, and the automatic open operation of the door to the predetermined amount can thus be appropriately carried out depending on the state. Moreover, before the door actually automatically starts to move to the predetermined amount, the door holding unit configured to generate the door holding force for holding the door is brought into the state of avoiding the generation of the holding force, and the open operation of automatically opening the door to the predetermined amount can thus be appropriately carried out.

Moreover, according to the one embodiment of the present invention, when the vehicle is inclined so that the open direction of the door of the vehicle, which serves as the operation object, is oriented toward the lower side of the vehicle, the holding force for holding the door is generated. Thus, when the door is opened from the inside of the vehicle in the inclined case, an unintentional run of the door by the self-weight can be reduced. Thus, the operation force required to manually open the vehicle door in the inclined case can be reduced.

### BRIEF DESCRIPTION OF DRAWINGS

FIG. 1 is a side view of a part of a vehicle according to an embodiment of the present invention.

FIG. 2 is a perspective view of a door holding apparatus when a side door is in a fully closed state according to the embodiment of the present invention.

FIG. 3 is a block diagram for illustrating a schematic configuration of a control system in a vehicle door drive apparatus according to the embodiment of the present invention.

FIG. 4A is a schematic diagram for illustrating a top surface of the side door when the side door is in the fully closed state according to the embodiment of the present invention.

FIG. 4B is a schematic diagram for illustrating the top surface of the side door when the side door is at a pop-up position according to the embodiment of the present invention.

FIG. 5 is a perspective view of the door holding apparatus when the side door is at the pop-up position according to the embodiment of the present invention.

FIG. 6 is a flowchart for illustrating a processing sequence of a pop-up open operation according to the embodiment of the present invention.

FIG. 7A is a diagram for illustrating a mode of changing a pop-up amount when the vehicle is inclined according to an embodiment of the present invention.

FIG. 7B is a diagram for illustrating a mode of changing a pop-up amount when the vehicle is inclined according to the embodiment of the present invention.

FIG. 8 is a block diagram for illustrating a schematic configuration of a control system in a vehicle door drive apparatus according to the embodiment of the present invention.

FIG. 9 is a flowchart for illustrating a processing sequence of a pop-up open operation according to the embodiment of the present invention.

FIG. 10 is a flowchart for illustrating a processing sequence of a pop-up open operation according to an embodiment of the present invention.

FIG. 11 is a block diagram for illustrating a schematic configuration of a control system in a vehicle door drive apparatus according to an embodiment of the present invention.

FIG. 12 is an operation chart of the vehicle door drive apparatus when the side door in the fully closed state is opened according to the embodiment of the present invention.

FIG. 13 is a flowchart for illustrating a processing sequence of a pop-up open operation according to the embodiment of the present invention.

FIG. 14 is a diagram for illustrating a mode of changing a holding force of the door holding apparatus depending on the inclination of the vehicle according to an embodiment of the present invention.

FIG. 15 is a block diagram for illustrating a schematic configuration of a control system in a vehicle door drive apparatus according to the embodiment of the present invention.

FIG. 16 is a flowchart for illustrating a processing sequence of changing the holding force depending on the inclination of the vehicle when the side door is opened from an inside of the vehicle according to the embodiment of the present invention.

### DESCRIPTION OF EMBODIMENTS

Embodiments of the present invention are described in the following with reference to the attached drawings, but the present invention is not limited to these embodiments. Components that have the same functions are denoted by the same reference symbols throughout the drawings referred to in the following description, and repetitive descriptions thereof may be omitted.

### First Embodiment

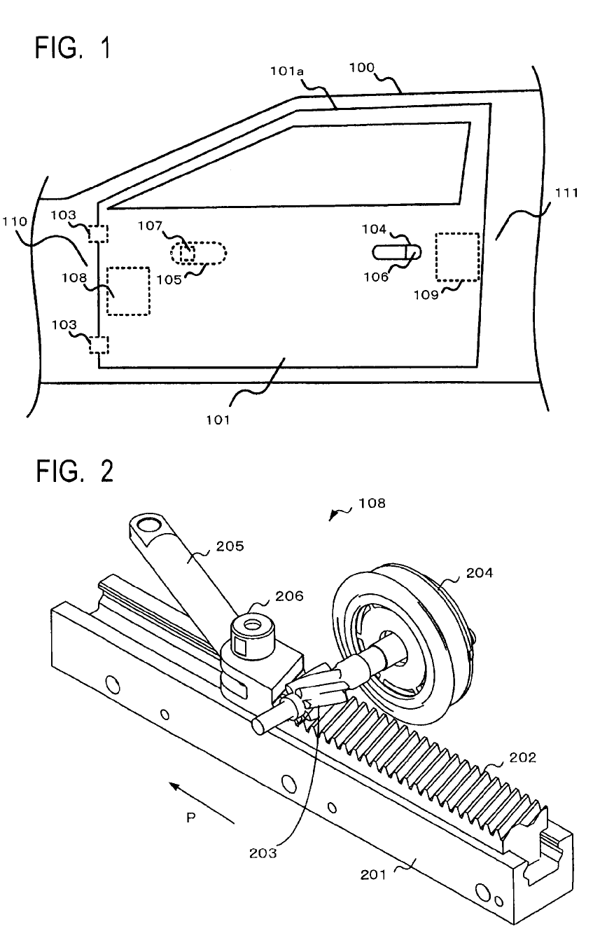

FIG. 1 is a side view of a part of a vehicle according to an embodiment of the present invention.

In FIG. 1, a vehicle 100 includes a side door 101 and an opening portion 101a which is formed in the vehicle 100 and through which a person passes to get into and off the vehicle 100. The side door 101 is fitted to the opening portion 101a, and is coupled to the opening portion 101a via a pair of hinges 103 at an edge part 110 on a vehicle front side of the opening portion 101a. Thus, the side door 101 can turn about the hinges 103. In other words, the side door 101 is a door of a swing type.

On a vehicle outer side of the side door 101, an outside handle 104 is provided. A switch 106 for a user to input a command for automatically opening the side door 104 in a fully closed state by a predetermined amount that does not bring the side door 101 into a fully open state is provided on the outside handle 104. An operation of automatically opening the side door 101 in the fully closed state by the predetermined amount that does not cause the fully open state is herein referred to as “pop-up open operation”, and “a command from the user to automatically open the side door 101 in the fully closed state by the predetermined amount that does not cause the fully open state” is referred to as “pop-up command”.

The user outside the vehicle 100 can operate the outside handle 104 or the switch 106 so as to open the side door 101 (open operation of the side door 101). In other words, the user can operate the outside handle 104 so as to manually open the side door 101. On the other hand, when the user depresses the switch 106, the side door 101 automatically opens by the predetermined amount that does not cause the fully open state through the pop-up open operation, and stops at the position opened by the predetermined amount. The user applies, to the side door 101 stopped at this position, such a force (operation force) as to turn the side door 101 toward the outside, to thereby manually open the side door 101 stopped at the stop position. In this way, the switch 106 functions as an input unit used by the user to input the pop-up command from the outside of the vehicle. Moreover, the state in which the switch 106 is depressed by the user represents a state in which the user operating the side door 101 is outside the vehicle 100. In other words, the input of the pop-up command on the switch 106 can be considered as an input of such a state of the user that the user is outside the vehicle 100. Thus, the switch 106 can be considered to function as an input unit configured to input such information on the state of the user that the user is inputting the pop-up command from the outside of the vehicle 100.

A position at which the pop-up open operation is finished (the above-mentioned stop position, namely, the position opened from the fully closed state of the side door 101 by the predetermined amount relating to the pop-up open operation) is herein referred to as “pop-up door position”.

On a vehicle inner side of the side door 101, an inside handle 105 is provided. On the inside handle 105, a switch 107 used by the user to input the pop-up command is provided.

The user inside the vehicle 100 can operate the inside handle 105 or the switch 107 to carry out the open operation of the side door 101. In other words, the user can operate the inside handle 105 to manually open the side door 101. On the other hand, when the user depresses the switch 107, the side door 101 automatically opens to the pop-up door position, and stops at the pop-up door position. The user applies, to the side door 101 stopped at this position, such a force (operation force) as to turn the side door 101 toward the outside, to thereby manually open the side door 101 stopped at the stop position. In this way, the switch 107 functions as an input unit used by the user to input the pop-up command from the inside of the vehicle. Moreover, the state in which the switch 107 is depressed by the user represents a state in which the user operating the side door 101 is inside the vehicle 100. In other words, the input of the pop-up command on the switch 107 can be considered as an input of such a state of the user that the user is inside the vehicle 100. Thus, the switch 107 can be considered to function as an input unit configured to input such information on the state of the user that the user is inputting the pop-up command from the inside of the vehicle 100.

Note that, as a matter of course, regardless of whether the operation is from the outside or the inside of the vehicle 101, when the user applies, to the side door 101, such an operation force as to turn the side door 101 toward the outside during the pop-up open operation, the side door 101 can be manually opened by the operation force.

The side door 101 further includes a door holding apparatus 108 configured to hold the side door 101 at a predetermined position (pop-up door position according to this embodiment) and a latch apparatus 109 configured to engage with a striker (not shown) provided on an edge part ill on a vehicle rear side of the opening portion 101a, to thereby hold the side door 101 in a closed state (the fully closed state or a door ajar state) with respect to the vehicle 101. The latch apparatus 109 includes a latch (not shown) and a pawl (not shown), and when the side door 101 is closed, the latch rotates so as to engage with the striker, and, simultaneously, the pawl stops the rotation of the latch so as to hold the side door 101 in the closed state. Moreover, when the pawl is moved to release the stop of the rotation of the latch, the engagement state between the latch and the striker is released, thereby bringing the side door 101 into a turnable state.

FIG. 2 is a perspective view of the door holding apparatus 108 when the side door 101 is in the fully closed state. The door holding apparatus 108 can hold the side door 101 at an arbitrary position, and thus has a so-called free stop function. The door holding apparatus 108 includes a rail 201 configured to be fixed inside the side door 101, a rack 202 configured to engage with the rail 201 so as to slide on the rail 201, a pinion 203 configured to mesh with the rack 202 so as to rotate by moving relatively to the rack, an electromagnetic brake 204 connected to the pinion 203, and a lever 205 connected to the rack 202. One end of the lever 205 is connected to the rack 202 so as to turn about a pin 206. The pinion 203 is connected to a shaft, which is a rotational shaft of the electromagnetic brake 204. Moreover, the other end of the lever 205 passes through an opening portion formed on a vehicle front side of the side door 101, and is coupled to the edge part 110 on the vehicle front side of the opening portion 101a via a bracket (not shown). The lever 205 turns about the pin 206 by the rack 202 manually or electrically sliding on the rail 201, and the side door 101 is opened/closed by the turn.

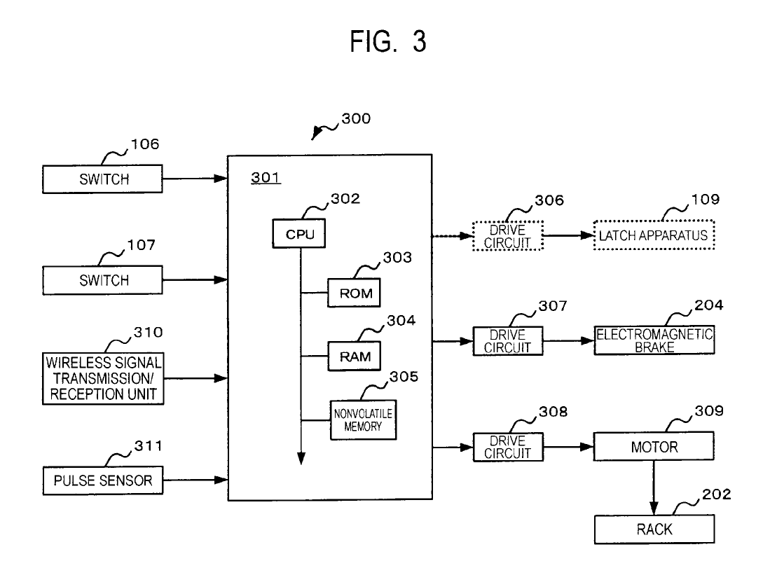

FIG. 3 is a block diagram for illustrating a schematic configuration of a control system in a vehicle door drive apparatus 300 according to the embodiment of the present invention.

The vehicle door drive apparatus 300 includes the switches 106 and 107 configured to be used by the user to input the pop-up command, the door holding apparatus 108, a drive circuit 307 configured to drive the electromagnetic brake 204 of the door holding apparatus 108, a motor 309 configured to displace the rack 202 of the door holding apparatus 108, a drive circuit 308 configured to drive the motor 309, a wireless signal transmission/reception unit 310 configured to transmit/receive a wireless signal to/from a wireless transmitter (not shown), a pulse sensor 311 configured to detect the opening degree of the side door 101, and a control apparatus 301.

In FIG. 3, the control apparatus 301 is a control portion constituting a control unit configured to control the entire vehicle door drive apparatus 300. Moreover, the control apparatus 301 may be configured to control the configurations such as the latch apparatus 109 other than the vehicle door drive apparatus 300. This control apparatus 301 includes a CPU 302 configured to execute processing operations such as various types of calculation, control, and discrimination, and a ROM 303 configured to store, for example, a control program for processing of FIG. 6 described later, which is executed by the CPU 302. Moreover, the control apparatus 301 includes a RAM 304 configured to temporarily store data under processing by the CPU 302 and input data, and a nonvolatile memory 305 such as a flash memory or an SRAM. Moreover, to the control apparatus 301, the switches 106 and 107 are connected. Thus, when the switch 106 or 107 is depressed by the user, the switch 106 or 107 transmits pop-up command information on the pop-up command to the control apparatus 301. Further, to the control apparatus 301, the latch apparatus 109, the electromagnetic brake 204, the motor 309, and the like are connected via drive circuits 306 to 308.

The wireless signal transmission/reception unit 310 transmits an ID information request signal at a predetermined time interval (transmission time interval) to the outside of the vehicle 100. Moreover, the wireless signal transmission/reception unit 310 receives an ID information signal transmitted from a predetermined wireless transmitter. The wireless transmitter is a portable apparatus having a wireless communication function such as a portable key, a smartphone, or a tablet having a communication function such as wireless communication, independent of the vehicle 100. The wireless transmitter holds ID information representing an ID of a predetermined vehicle in a memory unit. When the wireless transmitter receives the ID information request signal, the wireless transmitter transmits an ID information signal including the ID information for identifying the predetermined vehicle, which is stored in the own memory unit. The wireless signal transmission/reception unit 310 is to receive the ID information signal.

Note that, in this embodiment, the pop-up command may be input from the wireless transmitter. In this case, for example, a switch used by the user to input the pop-up command may be provided on the wireless transmitter. When the switch is depressed by the user, the wireless transmitter transmits the pop-up command information to the vehicle 100, and the wireless signal transmission/reception unit 310 receives the pop-up command information transmitted from the wireless transmitter. Thus, in this case, the wireless signal transmission/reception unit 310 functions as an input unit configured to input the pop-up command. Moreover, according to this embodiment, the pop-up open operation may be triggered by the user operating the outside handle 104 or the inside handle 105 so as to open the side door 101 in the fully closed state. In this case, the input unit of the pop-up command may be configured so that a switch configured to be turned on in association with the operation on the outside handle 104 and the inside handle 105 in the fully closed state is provided, and when this switch is turned on, the switch transmits the pop-up command information to the control apparatus 301.

The pulse sensor 311 is provided on the motor 309 configured to drive the rack 202 (lever 205), and is configured to transmit a pulse signal corresponding to the number of rotations of the motor 309 to the control apparatus 301. The control apparatus 301 can use the pulse signal received from the pulse sensor 311 to recognize the number of rotations of the motor 309. Thus, the control apparatus 301 can calculate a travel amount of the rack 202 from the number of rotations of the motor 309, and can recognize how much the side door 101 is opened (opening degree) from the travel amount. For example, dimensions of the members relating to the open operation of the side door 101 such as the rack 202, the lever 205, and the side door 101 are invariable, and the travel amount and the opening degree are thus associated with each other in a form of a table or a function. The control apparatus 301 can acquire the opening degree corresponding to the travel amount of the rack 202 by using the association.

Note that, according to this embodiment, any of a configuration may be used instead of the pulse sensor, such as a position sensor configured to detect the position of the side door 101, as long as the configuration can acquire the opening degree of the side door 101.

When the user operates the outside handle 104 or the inside handle 105 so as to carry out the open operation of the side door 101 in the fully closed state, as the user opens the side door 101, the rack 202 slides on the rail 201, and the lever 205 turns in operational association with the slide, resulting in the opening of the side door 101.

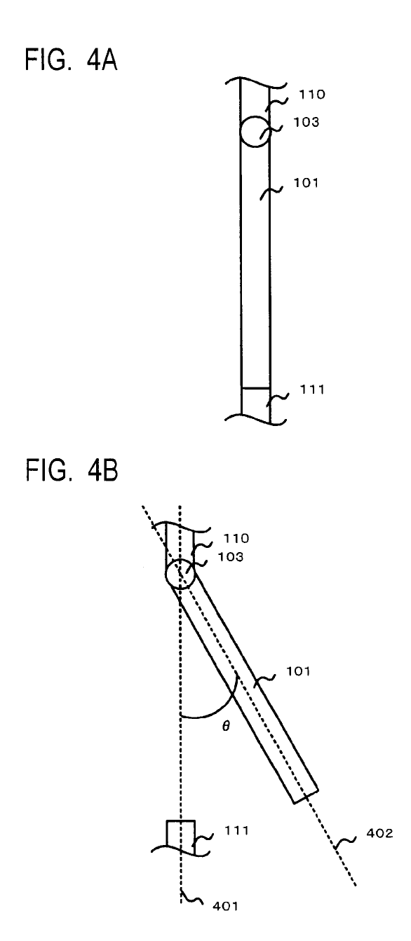

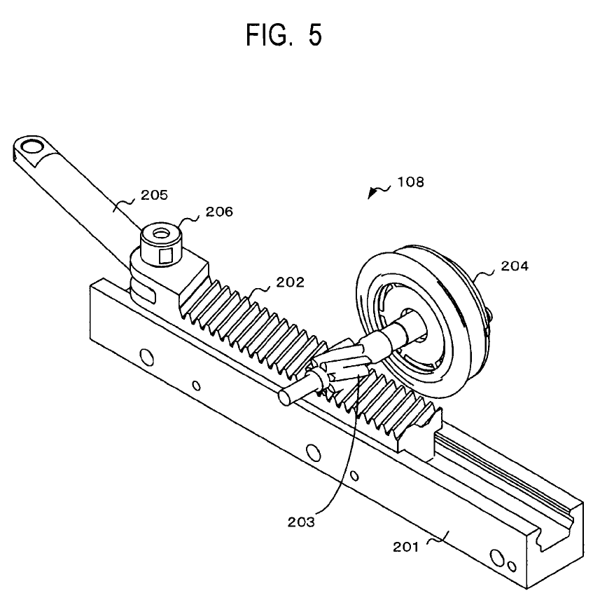

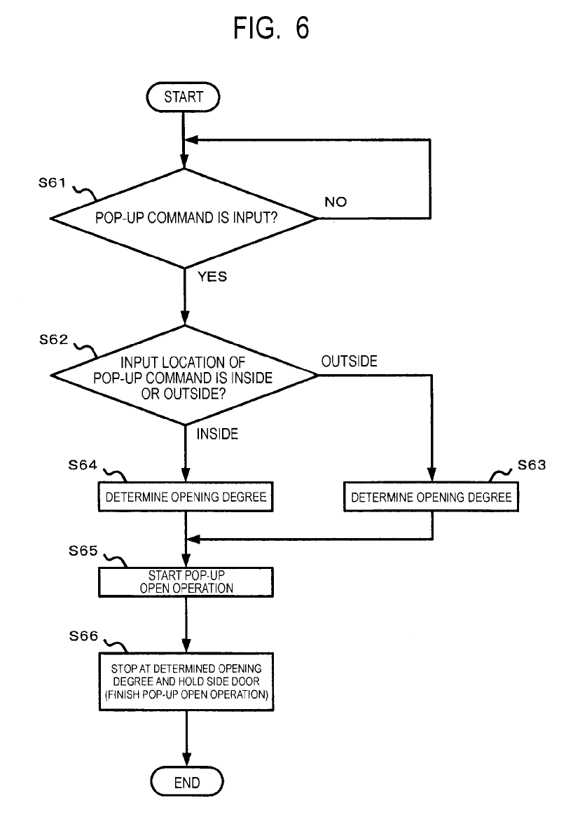

On the other hand, when the user operates the switch 106 or 107 so as to carry out the open operation of the side door 101 in the fully closed state, the motor 309 is driven by the drive circuit 308, the rack 202 moves toward the arrow P direction of FIG. 2, and the lever 205 turns as the rack 202 moves. In other words, the side door 101 in the fully closed state illustrated in FIG. 4A automatically starts to open so as to carry out the pop-up open operation. During the pop-up open operation, the rack 202 slides on the rail 201 by the motor 309, and, as a result, the side door 101 automatically opens. When the opening degree of the side door 101 is detected, based on the detection result by the pulse sensor 311, to be an opening degree θ (pop-up opening degree θ) corresponding to the state in which the side door 101 is at the pop-up position as illustrated in FIG. 4B, the drive circuit 308 is controlled to stop the drive of the motor 309, to thereby stop the moving rack 202. Simultaneously with the stop, a current is supplied to the electromagnetic brake 204 by the drive circuit 307 so that a predetermined holding torque (holding force) is generated. As a result, as illustrated in FIG. 5, the pinion 203 is held at a position corresponding to the pop-up position on the rack 202 by the holding force. Note that, the holding torque (holding force) is preferred to be a force at such a degree that the side door 101 can be held at the pop-up position, and, simultaneously, the user can easily open the side door 101 in this state. With this setting, the side door 101 can be automatically opened to the pop-up position, and, after the pop-up position, the user can manually open the side door.

Note that, according to this embodiment, the holding torque is generated by the electromagnetic brake 204, and the rack 202 is held, that is, the side door 101 is held by the holding torque (holding force). A configuration for holding the side door 101 is not limited to the electromagnetic brake, and any configuration may be used, such as an electromagnetic clutch, as long as the configuration can switch between the holding state and the non-holding state of the rack 202.

“Opening degree (pop-up amount)” of the side door 101 herein is an index representing how much the side door 101 is opened from the fully closed state. According to this embodiment, the opening degree refers to an angle between a direction 401 along the side door 101 vertical to a rotational axis direction of the hinges 103 of the side door 101 under the fully closed state and a direction 402 along the side door 101 vertical to the rotational axis direction of the hinges 103 of the side door 101 under the state in which the side door 101 is opened. As described above, the opening degree is the index relating to the angle, and thus what reference is used to determine the opening degree does not matter.

According to this embodiment, the side door 101 can be caused to carry out the pop-up open operation by the user depressing the switch 106 or the switch 107. As a result of the pop-up open operation, the side door 101 automatically opens to the pop-up opening degree θ (such as approximately 10°). Thus, the start of opening the side door 101 at which a sense of weight is felt in the open operation of the side door 101 in the fully closed state can be automatically carried out. Then, the user carries out the manual open operation on the side door 101 under the state in which the side door 101 is opened by the pop-up opening degree θ, and the operation force for the side door 101 can thus be reduced in the operation of opening the side door 101 in the fully closed state.

As described above, the pop-up open operation exerts a great effect on the opening of the side door 101 in the fully closed state, and is thus a very effective method. In this method of carrying out the pop-up open operation, the operability can further be increased by changing the pop-up amount depending on a state of the user to carry out the operation and a state of the vehicle.

For example, the pop-up amount (opening degree) is preferred to be changed depending on the position of the user inputting the pop-up command as the state of the user. In general, the inside handle is arranged in a front part (on a hinge side) of the side door. In this case, the position of the inside handle is close from the door rotational axis (hinge axis), and an operation force load on the user upon the opening of the side door in the fully closed state is high. Thus, according to this embodiment, when the input of the pop-up command is detected by means of the switch 107 (when the pop-up command is input from the inside of the vehicle 100), the pop-up open operation is carried out so that the opening degree of the side door 101 is large. As a result, the operation force upon the opening of the side door 101 in the fully closed state from the inside of the vehicle 100 can be reduced.

However, when the pop-up command is input from the outside of the vehicle 100, and, as described above, the pop-up amount is set to be large, the side door 101 during the pop-up open operation may hit the hand (such as the back of the hand) of the user. Thus, according to this embodiment, when the input of the pop-up command is detected by means of the switch 106 (when the pop-up command is input from the outside of the vehicle 100), the pop-up open operation is carried out so that the opening degree of the side door 101 is small. As a result, after the pop-up command is input, the hit of the side door 101 against the hand and the like of the user during the pop-up open operation can be prevented or reduced, and lowering of the operation feeling of the user can be prevented or reduced.

FIG. 6 is a flowchart for illustrating a processing sequence of the pop-up open operation in a case where the pop-up amount (opening degree) is changed depending on whether the position of inputting the pop-up command is the inside or the outside of the vehicle according to this embodiment. The processing sequence is processing executed by the CPU 302 of the control apparatus 301. Thus, the control of the processing is carried out by the CPU 302 reading a program for carrying out the processing illustrated in FIG. 6, which is stored in the ROM 303, and executing the program.

Note that, according to this embodiment, the switches 106 and 107 are configured to add information for identifying themselves to the pop-up command information. Note that, according to this embodiment, it is only required that the CPU 302 can identify the source of the pop-up command information, and thus any configuration can be employed as long as the pop-up command information transmitted from the switch 106 and the pop-up command information transmitted from the switch 107 can be discriminated from each other.

In Step S61, the control apparatus 301 determines whether or not the pop-up command is input by the user. When the switch 106 or the switch 107 is depressed by the user, the depressed switch transmits the pop-up command information to the control apparatus 301. When the control apparatus 301 receives the pop-up command information from the switch 106 or the switch 107, the control apparatus 301 determines that the pop-up command is input from the user, and proceeds to Step S62. On the other hand, when the control apparatus 301 does not receive the pop-up command information, the control apparatus 301 repeats Step S61 until the pop-up command information is received.

In Step S62, the control apparatus 301 determines whether the pop-up command is input from the inside of the vehicle 100 or is input from the outside of the vehicle 100 based on the pop-up command information received in Step S61. In other words, when the received pop-up command information is transmitted from the switch 106, the control apparatus 301 determines that the pop-up command is input from the outside of the vehicle 100. On the other hand, when the received pop-up command information is transmitted from the switch 107, the control apparatus 301 determines that the pop-up command is input from the inside of the vehicle 100.

In Step S63, the control apparatus 301 determines the pop-up opening degree θ. In other words, the control apparatus 301 sets, as the pop-up opening degree θ, an opening degree (outside input opening degree) for the case where the pop-up command is input from the outside (switch 106) of the vehicle 100. According to this embodiment, the outside input opening degree is set to be small.

According to this embodiment, the rack 202 and the lever 205 are moved by means of the drive of the motor 309 so as to open the side door 101. Thus, the opening degree of the side door 101 is considered to be controlled by the drive of the motor 309, and the number of rotations of the motor 309 and the opening degree of the side door 101 are associated with each other. According to this embodiment, the association is tabularized. Thus, the control apparatus 301 refers to the table to acquire the number of rotations of the motor 309 corresponding to the predetermined opening degree. Note that, the association may be made into a function, and the function may be used to calculate the number of rotations corresponding to the predetermined opening degree.

In this step, after the determination of the outside input opening degree, the control apparatus 301 refers to the table to acquire the number of rotations (outside input number of rotations) of the motor 309 corresponding to the outside input opening degree.

In Step S64, the control apparatus 301 determines the pop-up opening degree θ. In other words, the control apparatus 301 sets, as the pop-up opening degree θ, an opening degree (inside input opening degree) for the case where the pop-up command is input from the inside (switch 107) of the vehicle 100. The inside input opening degree is an opening degree less than the fully open state of the side door 101, and is an opening degree more than the outside input opening degree. After the determination of the inside input opening degree, the control apparatus 301 refers to the table to acquire the number of rotations (inside input number of rotations) of the motor 309 corresponding to the inside input opening degree.

Note that, according to this embodiment, the outside input opening degree and the inside input opening degree are set in advance, but, as a matter of course, these values may be changed by the user.

In Step S65, the control apparatus 301 starts the pop-up open operation for the pop-up opening degree θ determined in Step S63 or Step S64. In other words, the control apparatus 301 controls the drive circuit 308 to drive the motor 309, to thereby slide the rack 202 in the fully closed state as illustrated in FIG. 2 on the rail 201 toward the arrow P direction. With this slide, the lever 205 turns, and the side door 101 automatically opens. On this occasion, the control apparatus 301 acquires the pulse signal from the pulse sensor 311 as needed so as to monitor the travel distance of the rack, namely, the opening degree of the side door 101 (number of rotations of the motor 309).

In Step S66, the control apparatus 301 stops the automatically opening side door 101 when the opening degree of the side door 101 in the pop-up open operation reaches the set pop-up opening degree θ, and holds the side door 101 at the stop position (pop-up door position). In other words, when the current number of rotations of the motor 309 matches the number of rotations corresponding to the determined pop-up opening degree based on the pulse signal from the pulse sensor 311, the control apparatus 301 controls the drive circuit 308 to stop the current supply to the motor 309, to thereby stop the drive of the motor 309. As a result, the rack 202 stops, and the automatic open operation of the side door 101 also stops. For example, when the pop-up command is input by using the switch 106, and the number of rotations of the motor 309 reaches the outside input number of rotations based on the detection result by the pulse sensor 311, the drive of the motor 309 is stopped. On the other hand, when the pop-up command is input by using the switch 107, and the number of rotations of the motor 309 reaches the inside input number of rotations based on the detection result by the pulse sensor 311, the drive of the motor 309 is stopped. With this control, the pop-up amount changes depending on whether the input position of the pop-up command is the inside or the outside of the vehicle 100. The control apparatus 301 stops the motor 309, and simultaneously controls the drive circuit 307 to supply a current to the electromagnetic brake 204, to thereby generate the holding torque (holding force). With this control, the side door 101 is held by the action of the electromagnetic brake 204 at the stop position of the side door 101. In this way, the pop-up open operation is finished in this step.

According to this embodiment, the control for the pop-up amount (opening degree) is carried out by the number of rotations of the motor 309, but the control is not limited to this configuration. For example, the pop-up amount may be controlled based on a current supply period from the control circuit 308 to the motor 309. As the current supply period to the motor 309 increases, the opening degree of the side door 101 increases. For the inside input opening degree, which is the relatively large opening degree, the current supply period to the motor 309 may be set to be larger than that for the outside input opening degree.

Moreover, for example, a first switch configured to be depressed by a predetermined member when the opening degree of the side door 101 reaches the outside input opening degree and a second switch configured to be depressed by a predetermined member when the opening degree of the side door 101 reaches the inside input opening degree may be provided on the lever 205. In this case, when the pop-up command is input from the outside of the vehicle 100, and the first switch is thus depressed, the control apparatus 301 stops the drive of the motor 309. On the other hand, when the pop-up command is input from the inside of the vehicle 100, and the second switch is thus depressed, the control apparatus 301 stops the drive of the motor 309. With this configuration, when the motor 309 is stopped, the opening degree of the side door 101 is the desired pop-up opening degree (outside input opening degree or inside input opening degree).

In this embodiment, the feeling in the operation is different between the inside and the outside of the side door 101, and the pop-up amount is thus changed depending on the operation position of the side door 101 (state of the user). In other words, the vehicle 100 determines the operation position of the side door 101 of the user (state of the user) based on the command input from the switch 106 or 107, determines the optimal pop-up opening degree for the operation position, and carries out the pop-up open operation for the pop-up opening degree. Specifically, the pop-up opening degree θ is set to be small for the entrance to the vehicle (in the case where the pop-up command is input from the outside of the vehicle). Thus, during the pop-up open operation, the hit of the side door 101 against the user is prevented or reduced. Moreover, the pop-up opening degree θ is set to be large for an exit from the vehicle (in the case where the pop-up command is input from the inside of the vehicle). Thus, after the pop-up open operation is finished, the operation force required to manually open the side door 101 located at the pop-up door position can be reduced. In this way, according to this embodiment, regardless of the operation portion and the posture of the user for the entrance to the vehicle and the exit from the vehicle, the open/close feeling of the side door 101 can be improved.

Note that, when the pop-up command is input by the wireless transmitter, the user is assumed to enter the vehicle while carrying luggage on both hands, and the pop-up opening degree θ may thus be large. With this setting, even when the user is carrying luggage on both hands, the side door 101 automatically opens to a large opening degree, and hence a manual open operation of the side door 101 subsequent to the pop-up door position can be carried out by the elbow, for example.

Moreover, as an example of automatically changing the pop-up amount depending on the state of the user, the pop-up opening degree may be changed depending on the physique of the user, which is specific to the operation from the inside of the vehicle 100. As an example, it is only required to provide a seating sensor configured to be able to detect a load value and a load distribution in a seat in the vehicle 100 as a physique detection sensor configured to detect the physique of the user, and to connect the seating sensor to the control apparatus 301. Alternatively, a seat position sensor configured to be able to detect at least one of a longitudinal position, a vertical position, or an angle of the seat may be provided on the seat as the physique detection sensor, and the seat position sensor may be connected to the control apparatus 301. In this case, the seat may be a power seat or a manual seat. The physique detection sensor functions as an input unit configured to input the information on the physique of the user as the state of the user.

In this mode, the weight and the physique of a person seating on the seat are detected by the physique detection sensor such as the seating sensor and the seat position sensor, and information on the weight and the physique of the person detected by the physique detection sensor is transmitted to the control apparatus 301. The control apparatus 301 determines the pop-up opening degree θ depending on the information on the weight and the physique of the person received from the physique detection sensor. For example, when the person seating on the seat is determined to be a woman or a child based on the detection result by the physique detection sensor, the pop-up opening degree θ may be set to be large, or as the physique increases, the pop-up opening degree θ may be set to increase stepwise. By setting in this way, the operation of opening the side door 101 from the inside of the vehicle 100 can be assisted depending on the physique of the user. Moreover, when an object on the seat is determined not to be a person but to be a child safety seat by the physique detection sensor, the pop-up opening degree θ may be set to 0°.

### Second Embodiment

In the first embodiment, a description is given of such a mode that the pop-up amount is changed depending on the state of the user. In this embodiment, a description is given of such a mode that the pop-up amount is changed depending on a state of the vehicle 100 (such as an environment in which the vehicle 100 exists).

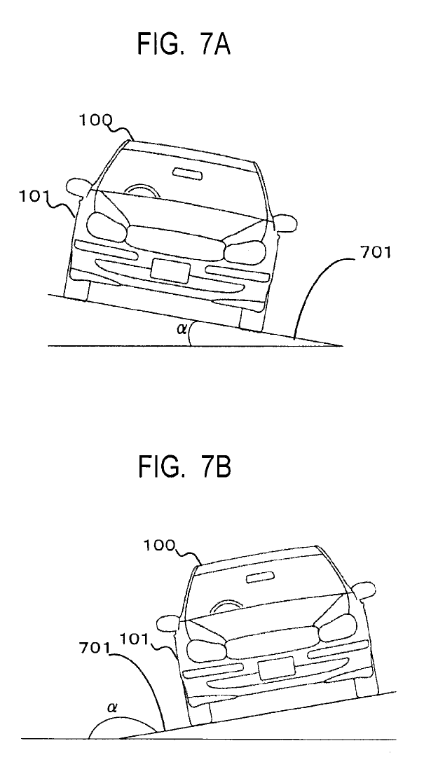

According to this embodiment, the pop-up amount is changed depending on an attitude (particularly a widthwise inclination) of the vehicle 100 as the state of the vehicle 100. In other words, as illustrated in FIG. 7A and FIG. 7B, when the vehicle 100 is inclined in a door open direction (direction toward which the door opens) of the side door 101 of the vehicle 100, the pop-up amount is changed depending on an inclination angle α of the slope.

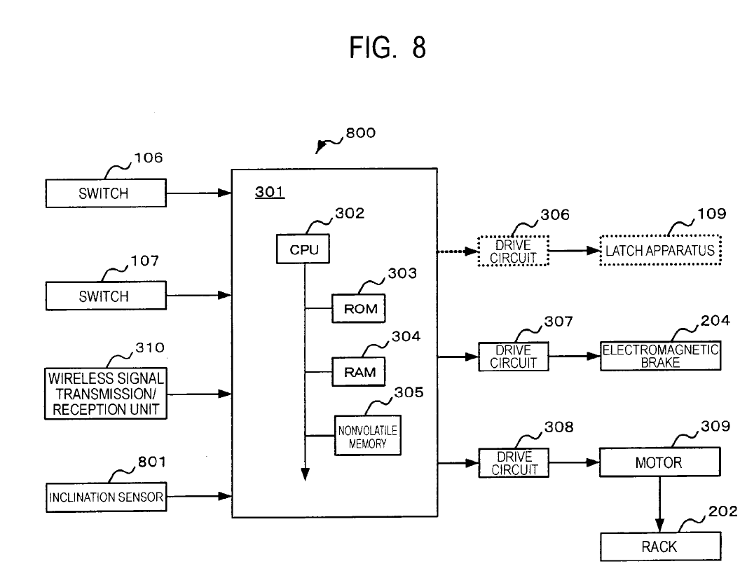

FIG. 8 is a block diagram for illustrating a schematic configuration of a control system in a vehicle door drive apparatus 800 according to this embodiment.

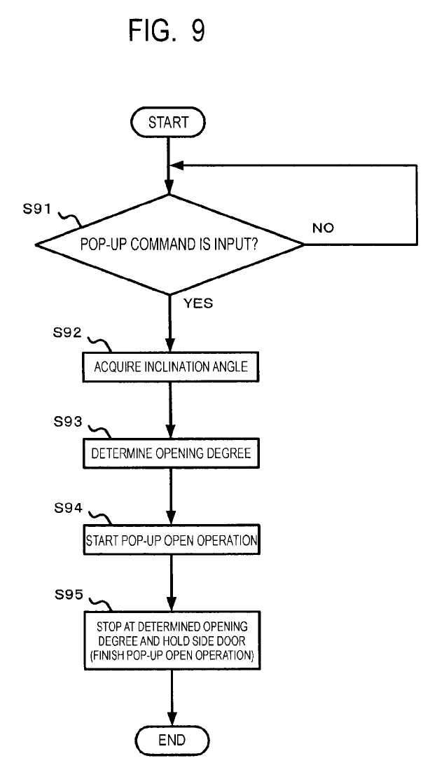

The vehicle door drive apparatus 800 includes the switches 106 and 107, the door holding apparatus 108, the drive circuit 307, the motor 309, the drive circuit 308, the wireless signal transmission/reception unit 310, an inclination sensor 801 configured to detect the inclination angle of the vehicle 100, and the control apparatus 301. Note that, in this embodiment, a control program illustrated in FIG. 9 is stored in the ROM 303.

The inclination sensor 801 is a three-axis acceleration sensor provided on the vehicle 100 and configured to be able to detect the inclination of the vehicle 100. Thus, the inclination sensor 801 can detect the inclination angle α in FIG. 7A and FIG. 7B corresponding to the inclination in the door open direction of the vehicle 100, and transmits inclination angle information on the inclination angle α to the control apparatus 301. In this way, the inclination sensor 801 inputs the information on the inclination of the vehicle 100, and thus functions as an input unit configured to input the information on the state of the vehicle 100.

FIG. 9 is a flowchart for illustrating a processing sequence of the pop-up open operation in a case where the pop-up amount (opening degree) is changed depending on the inclination of the vehicle according to this embodiment. The processing sequence is processing executed by the CPU 302 of the control apparatus 301. Thus, the control of the processing is carried out by the CPU 302 reading a program for carrying out the processing illustrated in FIG. 9, which is stored in the ROM 303, and executing the program.

In Step S91, the control apparatus 301 determines whether or not the pop-up command is input by the user. When the switch 106 or the switch 107 is depressed by the user, the depressed switch transmits the pop-up command information to the control apparatus 301. When the control apparatus 301 receives the pop-up command information from the switch 106 or the switch 107, the control apparatus 301 determines that the pop-up command is input from the user, and proceeds to Step S92. On the other hand, when the control apparatus 301 does not receive the pop-up command information, the control apparatus 301 repeats Step S91 until the pop-up command information is received.

In Step S92, the control apparatus 301 acquires the inclination angle information from the inclination sensor 801, and acquires the inclination angle α in the door open direction of the side door 101 of the vehicle 100.

In Step S93, the control apparatus 301 determines the pop-up opening degree θ depending on the inclination angle α acquired in Step S92. In other words, the control apparatus 301 sets, as the pop-up opening degree θ, the opening degree corresponding to the inclination angle α of the vehicle 100. According to this embodiment, when the side door 101 tends to close by itself by the door self-weight (FIG. 7A), the pop-up opening degree θ is set to be large. This case is assumed when 0<inclination angle α<90°. Note that, a slope having a large inclination angle is unrealistic. On the other hand, when the side door 101 tends to open by itself by the door self-weight (FIG. 7B), the pop-up opening degree θ is set to be small or 0°. This case is assumed when 90°<inclination angle α<180°. Thus, when the inclination angle α acquired in Step S92 is in the range of 0<inclination angle α<90°, the control apparatus 301 determines that the side door 101 is in a state to close by itself by the door self-weight, and sets the pop-up opening degree θ to a first opening degree, which is a large value. Moreover, when the inclination angle α acquired in Step S92 is in the range of 90°<inclination angle α<180°, the control apparatus 301 determines that the side door 101 is in a state to open by itself by the door self-weight, and sets the pop-up opening degree θ to a second opening degree, which is a small value.

Note that, when the inclination angle α is 0° or 180°, the pop-up opening degree θ is only required to be determined as in Steps S62 to S64. Moreover, a case where the inclination angle α is 90° is unrealistic, and is not thus considered in this embodiment.

In Step S94, as in Step S65, the control apparatus 301 starts the pop-up open operation for the pop-up opening degree θ determined in Step S93. In Step S95, as in Step S66, the control apparatus 301 stops the automatically opening side door 101 when the opening degree of the side door 101 in the pop-up open operation reaches the set pop-up opening degree θ, and holds the side door 101 at the stop position (pop-up door position). In other words, the pop-up open operation is finished in this step.

As described above, according to this embodiment, as illustrated in FIG. 7A, when the vehicle is inclined so that the side door 101 tends to close by itself by the door self-weight, the pop-up opening degree θ is set to be large. Thus, the force required for the operation at the start of the opening of the side door 101 from the fully closed state can be decreased. On the other hand, as illustrated in FIG. 7B, when the vehicle is inclined so that the side door 101 tends to open by itself by the door self-weight, the pop-up opening degree θ is set to be small. Thus, the opening of the side door 101 by itself can be prevented from being promoted when the side door 101 is opened from the fully closed state.

In the description given above, the attitude (inclination) of the vehicle 100 is employed as the state of the vehicle 100, but even when the vehicle 100 is exposed to rain, this embodiment can be applied. In this case, in FIG. 8, the inclination sensor 801 is only required to be changed to a raindrop sensor. In other words, it is only required to detect a rainfall state by the raindrop sensor, and to set the pop-up amount (pop-up opening degree θ) depending on the state of the rain in which the vehicle 100 exists. For example, when a rainfall amount is determined to be large by the raindrop sensor, the control apparatus 301 sets the pop-up opening degree θ to be small. On the other hand, when the rainfall amount is determined to be small by the raindrop sensor, the control apparatus 301 sets the pop-up opening degree θ to be large. In this way, the raindrop sensor inputs the information on the amount of the rain around the vehicle 100, and thus functions as an input unit configured to input the information on the state of the vehicle 100.

Moreover, as the state of the vehicle 100, a vehicle outside temperature may be focused on. In this case, in FIG. 8, the inclination sensor 801 is only required to be changed to a temperature sensor configured to measure a temperature outside the vehicle 100. In other words, it is only required to detect the vehicle outside temperature of the vehicle 100 by the temperature sensor, and to set the pop-up amount (pop-up opening degree θ) depending on the vehicle outside temperature. For example, when the vehicle outside temperature is determined to be a low temperature by the temperature sensor, the control apparatus 301 sets the pop-up opening degree θ to be larger than that at a normal temperature or a high temperature. With this control, reduction in a weather strip reaction force can be decreased, and increase in the operation force for the side door 101 caused by the weather strip adhesion to the side door 101 due to freezing can be improved. In this way, the temperature sensor inputs the information on the temperature around the vehicle 100, and thus functions as an input unit configured to input the information on the state of the vehicle 100.

Further, the pop-up opening degree θ may be set depending on a detection state of a vehicle outside obstacle sensor such as a distance measurement sensor and a vehicle outside camera (such as an around view monitor). For example, when the vehicle outside obstacle sensor is used, in FIG. 8, the inclination sensor 801 is only required to be changed to the vehicle outside obstacle sensor. The vehicle outside obstacle sensor is provided on the side door 101, detects an obstacle present within a predetermined range, and transmits detection information to the control apparatus 301. For example, when an obstacle is determined to be detected by the vehicle outside obstacle sensor, the control apparatus 301 sets the pop-up opening degree θ to be 0°. Alternatively, when the vehicle outside obstacle sensor can acquire a distance to the obstacle, the control apparatus 301 may calculate a distance from the side door 101 to the obstacle based on the detection information, and set an opening degree at which the side door 101 does not hit the obstacle as the pop-up opening degree θ. When the vehicle outside camera is used, whether or not an obstacle exists on an estimated trajectory of the side door 101 is only required to be determined by means of image processing of acquired image data or the like. In this way, the vehicle outside obstacle sensor or the vehicle outside camera inputs the information on whether or not an obstacle exists around the vehicle 100, and thus functions as an input unit configured to input the information on the state of the vehicle 100.

### Third Embodiment

According to the first and second embodiments, the vehicle itself determines the state of the user (such as from which location the user inputs the pop-up command, the physique of the user, and whether or not a child safety seat is installed) or the state of the vehicle (such as the inclination of the vehicle, how much rain the vehicle is exposed to, the vehicle outside temperature, and whether or not an obstacle exists close to the vehicle), and changes the pop-up amount depending on the determination result. This embodiment is such a mode that the user arbitrarily changes the pop-up amount. In other words, according to this embodiment, the pop-up amount is determined depending on an operation amount (amount relating to a predetermined operation) for determining the pop-up amount, which is input by the user.

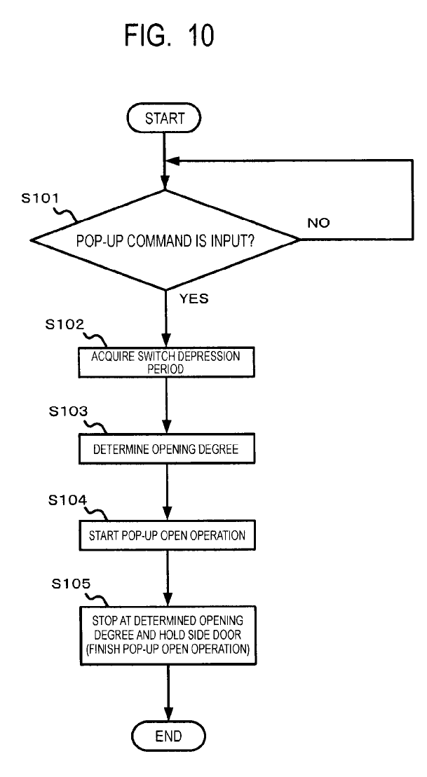

For example, in the vehicle door drive apparatus 300 illustrated in FIG. 3, the pop-up amount may be changed depending on, as the operation amount for determining the pop-up amount, a period in which the user is depressing the switch 106 or 107. FIG. 10 is a flowchart for illustrating a processing sequence of the pop-up open operation when the pop-up amount (opening degree) is changed depending on the depression period of the switch according to this embodiment. The processing sequence is processing executed by the CPU 302 of the control apparatus 301. Thus, the control of the processing is carried out by the CPU 302 reading a program for carrying out the processing illustrated in FIG. 10, which is stored in the ROM 303, and executing the program.

Note that, according to this embodiment, the vehicle door drive apparatus 300 further includes a timer (not shown) configured to be able to measure an elapsed period.

In Step S101, the control apparatus 301 determines whether or not the pop-up command is input by the user. When the switch 106 or the switch 107 is depressed by the user, the depressed switch transmits the pop-up command information to the control apparatus 301. When the control apparatus 301 receives the pop-up command information from the switch 106 or the switch 107, the control apparatus 301 determines that the pop-up command is input from the user, and proceeds to Step S102. On this occasion, the control apparatus 301 starts the count of the timer. On the other hand, when the control apparatus 301 does not receive the pop-up command information, the control apparatus 301 repeats Step S91 until the pop-up command information is received. Note that, according to this embodiment, the switches 106 and 107 are configured to transmit the pop-up command information to the control apparatus 301 while the switch 106 or the switch 107 is being depressed by the user. Thus, when the switch 106 or 107 is depressed for X seconds by the user, the switch 106 or 107 transmits the pop-up command information to the control apparatus 301 for X seconds.

In Step S102, the control apparatus 301 acquires the period in which the user is depressing the switch 106 or the switch 107 based on the pop-up command information transmitted from the switch 106 or the switch 107. The control apparatus 301 monitors the timer started when the pop-up command information is determined to be received in Step S101, to thereby acquire the switch depression period by the user. In other words, when the reception of the pop-up command information from the depressed switch is finished, the control apparatus 301 refers to the timer, to thereby acquire a finish time, and sets the switch depression period based on the finish time.

In Step S103, the control apparatus 301 determines the pop-up opening degree θ depending on the switch depression period acquired in Step S102. According to this embodiment, the switch depression period and the pop-up opening degree θ are tabularized. For example, it is only required to prepare a table associating the switch depression period and the pop-up opening degree θ with each other so that when the switch depression period is less than 1 second, the pop-up opening degree θ is set to 5°, when the switch depression period is from 1 second to 3 seconds, the pop-up opening degree θ is set to 10°, and when the switch depression period is 3 seconds or more, the pop-up opening degree θ is set to 15°. When this table is used, and the switch depression period acquired in Step S102 is 2.5 seconds, the control apparatus 301 refers to the table to determine that the pop-up opening degree θ is 10°. In this way, the pop-up opening degree θ is changed depending on the switch depression period. Thus, depending on the switch depression period, which is the operation amount relating to the operation of the user of depressing the switch, the pop-up opening degree θ is determined.

In Step S104, as in Step S65, the control apparatus 301 starts the pop-up open operation for the pop-up opening degree θ determined in Step S103. In Step S105, as in Step S66, the control apparatus 301 stops the automatically opening side door 101 when the opening degree of the side door 101 in the pop-up open operation reaches the set pop-up opening degree θ, and holds the side door 101 at the stop position (pop-up door position). In other words, the pop-up open operation is finished in this step.

Note that, according to this embodiment, the depression of the switch 106 or 107 by the user and the pop-up open operation may be operationally associated with each other. In this case, the start of the depression of the switch 106 or 107 by the user is considered as a trigger for the start of the drive of the motor 309, and the end of the depression of the switch 106 or 107 by the user is considered as a trigger for the end of the drive of the motor 309. In other words, the control apparatus 301 detects the start of the depression of the switch 106 or 107 by the user, to thereby drive the motor 309. As a result, the side door 101 starts the pop-up open operation. Then, when the control apparatus 301 detects the end of the depression of the switch 106 or 107 by the user, the control apparatus 301 stops the drive of the motor 309, and simultaneously drives the electromagnetic brake 204, to thereby hold the side door 101 at the stop position by the predetermined holding force. With this control, the pop-up open operation can be carried out in correspondence to the period of the depression of the switch by the user.

In this way, according to this embodiment, the pop-up amount is changed depending on the operation of the start trigger (input of the pop-up command) for the pop-up open operation by the user. Thus, the pop-up door position can be set depending on desire of the user. Thus, an appropriate pop-up open operation can be carried out depending on the state around the side door 101 upon the entrance to and exit from the vehicle 100.

Note that, according to this embodiment, by using the depression period of the switch by the user as the operation amount for determining the pop-up amount, the corresponding opening degree is selected from the plurality of pop-up opening degrees θ set in advance. However, the operation amount of the user for determining the pop-up amount is not limited to the depression period. For example, the above-mentioned selection may be made depending on the number of times of depression of the switch 106 or 107 as the operation amount. In this case, it is only required to prepare a table associating the number of times of switch depression and the pop-up opening degree θ with each other so that when the number of times of switch depression is one, the pop-up opening degree θ is set to 5°, when the number of times of switch depression is two, the pop-up opening degree θ is set to 10°, and when the number of times of switch depression is three or more, the pop-up opening degree θ is set to 15°.

Alternatively, for example, when the user uses a wireless transmitter including a touch panel constituting a user interface, such as a smartphone, to input the pop-up command by means of a swipe or a flick, the above-mentioned selection may be made depending on a swipe amount or a flick amount as the operation amount. In this case, it is only required to prepare a table associating the swipe amount or the flick amount and the pop-up opening degree θ with each other so that when the swipe amount or the flick amount is less than 1 cm, the pop-up opening degree θ is set to 5°, when the swipe amount or the flick amount is from 1 cm to 3 cm, the pop-up opening degree θ is set to 10°, and when the swipe amount or the flick amount is 3 cm or more, the pop-up opening degree θ is set to 15°.

This embodiment is not limited to such a mode of selecting one pop-up amount from the plurality of pop-up amounts set in advance depending on the operation method of the start trigger for the pop-up open operation (such as the difference in the depression period of the switch, the number of times of the operation, the swipe amount, and the flick amount). The essence of this embodiment resides in changing the pop-up amount depending on the intention of the user. Thus, as long as the essence is realized, any mode can be taken. For example, a certain relationship may be set between the operation method and the pop-up amount, and, based on the relationship, the pop-up amount corresponding to the input operation method may be used. When the case of the switch depression period is described as an example, it is only required to prepare such a function that as the switch depression period increases, the pop-up opening degree θ increases. In this case, the control apparatus 301 uses the function, to thereby calculate the pop-up opening degree θ corresponding to the switch depression period acquired in Step S102, and carries out Steps S104 and S105 for the calculated pop-up opening degree θ.

### Fourth Embodiment

The door holding apparatus 108 described in the first to third embodiments uses the electromagnetic brake 204 so as to control the holding of the rack 202 operationally in associated with the movement of the side door 101. In other words, the holding force for the side door 101 is controlled by the current supply to the electromagnetic brake 204. Thus, when the holding torque is generated by the current supply control for the electromagnetic brake 204, the rack 202 can be held by a predetermined holding force regardless of the relative position between the rack 202 and the pinion 203. In other words, the side door 101 can be held at an arbitrary opening degree by using the holding force. Thus, for example, while the user is manually opening/closing the side door 101, when the user manually stops the side door 101 at an arbitrary position between the fully closed state and the fully open state, detection of the stop of the opening/closing of the side door 101 can trigger the generation of the predetermined holding force at the current position so as to hold the side door 101.

On the other hand, as described above, in the pop-up open operation, it is required to automatically open the side door 101 to the set pop-up door position. Thus, during the pop-up operation, when the predetermined holding torque is generated by the electromagnetic brake 204, resulting in generation of the holding force for holding the side door 101, the action of automatically opening the side door 101 and the action of holding the side door 101 at the position coexist, which causes such a fear that the pop-up open operation does not appropriately function. Then, according to this embodiment, the holding force of the electromagnetic brake 204 is not generated (the state of holding the side door 101 is forcibly turned off) during the pop-up open operation. After the side door 101 reaches the pop-up door position, the state of holding the side door 101 or the state of not holding the side door 101 is selected depending on the state of the side door 101 (whether moving or not).

Note that, a state in which the holding force for holding the side door by means of the electromagnetic brake or the like is zero (state in which the holding torque by the electromagnetic brake or the like is zero) is herein referred to as “free state”. Moreover, the state in which the holding force (holding torque) for holding the side door by means of the electromagnetic brake or the like is generated (state in which the holding torque of the electromagnetic brake or the like intended for holding the side door is generated) is referred to as “holding state”. Further, a state in which, immediately after the pop-up door open operation is finished, the control apparatus 301 such as a computer adjusts the state between the free state and the holding state depending on the state of the side door 101 is referred to as “voltage control state”. According to this embodiment, simultaneously with the finish of the pop-up open operation, the state transitions to the voltage control state. Thus, when the pop-up open operation is finished, and the side door 101 is not manually moved, the holding state is brought about. On the other hand, when the pop-up open operation is finished, and the side door 101 is manually moved, the free state is brought about. In this way, the state in which, after the pop-up open operation is finished, whether the state is set to the free state or the holding state is selected depending on the movement of the side door 101 is referred to as voltage control state.

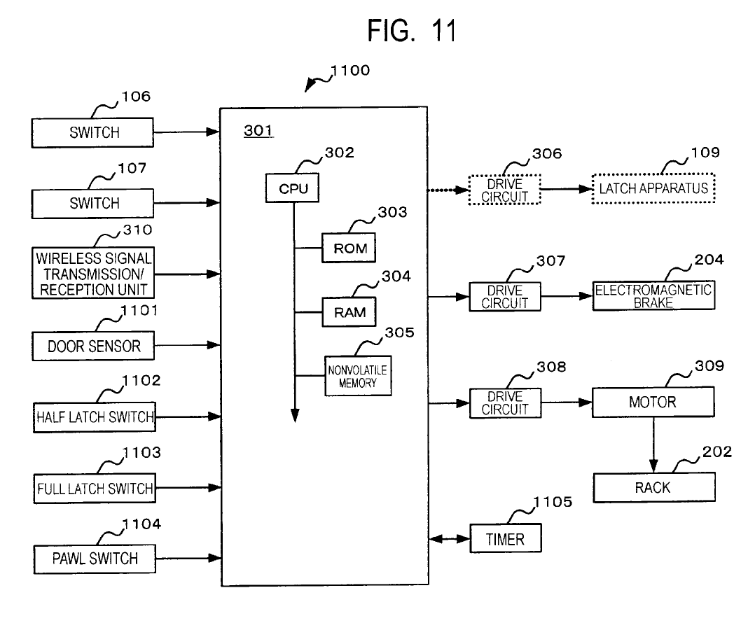

FIG. 11 is a block diagram for illustrating a schematic configuration of a control system in a vehicle door drive apparatus 1100 according to this embodiment.

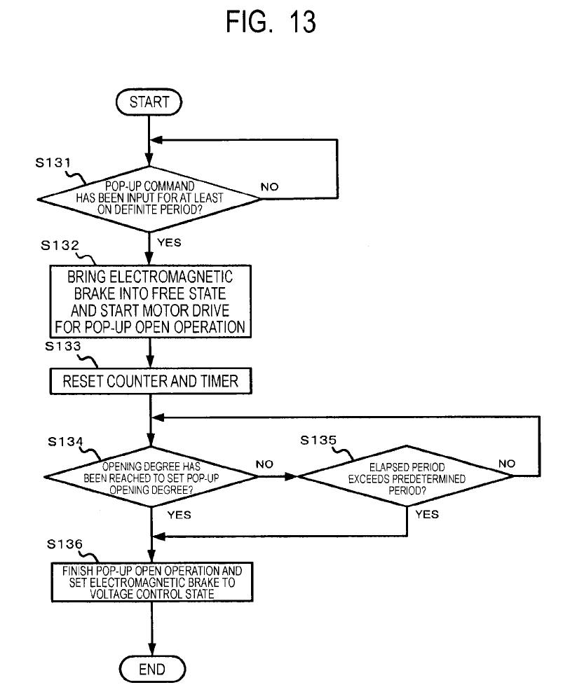

The vehicle door drive apparatus 1100 includes the switches 106 and 107, the door holding apparatus 108, the drive circuit 307, the motor 309, the drive circuit 308, the wireless signal transmission/reception unit 310, a door sensor 1101 configured to detect the movement of the side door 101, a half latch switch 1102, a full latch switch 1103, a pawl switch 1104, a timer 1105, and the control apparatus 301. Note that, in this embodiment, a control program illustrated in FIG. 13 is stored in the ROM 303.

The half latch switch 1102, the full latch switch 1103, and the pawl switch 1104 are respectively provided on the latch apparatus 109. The half latch switch 1102 is turned on when the latch of the latch apparatus 109 is on an open side with respect to a half latch position, and is turned off when the latch is on a closed side with respect to the half latch position. The full latch switch 1103 is turned on when the latch is on an open side with respect to a full latch position, and is turned off when the latch is on a closed side with respect to the full latch position. The pawl switch 1104 is turned on when the latch and the pawl of the latch apparatus 109 do not mesh with each other, and is turned off when the latch and the pawl mesh with each other.

According to this embodiment, the pawl of the latch apparatus 109 and the latch of the latch apparatus 109 are meshing with each other in the full latch position, the side door 101 is in the fully closed state. On this occasion, the half latch switch 1102, the full latch switch 1103, and the pawl switch 1104 are respectively off. Moreover, when the pawl and the latch are meshing with each other in the half latch position, the side door 101 is in the door ajar state. On this occasion, the half latch switch 1102 is off, and the full latch switch 1103 and the pawl switch 1104 are on. Further, when the pawl and the latch are not meshing with each other, the side door 101 is carrying out the open operation including the pop-up open operation. On this occasion, the half latch switch 1102, the full latch switch 1103, and the pawl switch 1104 are respectively on. Thus, depending on a combination of the on/off signals of the half latch switch 1102, the full latch switch 1103, and the pawl switch 1104, the control apparatus 301 can detect whether the side door 101 is in the fully closed state, the door ajar state, or the open state.

The door sensor 1101 is a position sensor provided on the side door 101, and is configured to transmit a pulse signal to the control apparatus 301 depending on the movement of the side door 101. The door sensor 1101 is a Hall device, a photo sensor, or the like. The control apparatus 301 can calculate the opening degree of the side door 101 based on the pulse signal transmitted from the door sensor 1101.

The timer 1105 is a time measurement apparatus configured to be able to measure an elapse of time, and to transmit time point information on a current time point to the control apparatus 301.

According to this embodiment, in the fully closed state (all the half latch switch 1102, the full latch switch 1103, and the pawl switch 1104 are off), the electromagnetic brake 204 is caused to generate the maximum holding torque (maximum holding force). In other words, in the fully closed state, the side door 101 is held by the maximum holding force. Note that, in the fully closed state, the electromagnetic brake 204 may generate a holding torque smaller than the maximum holding torque.

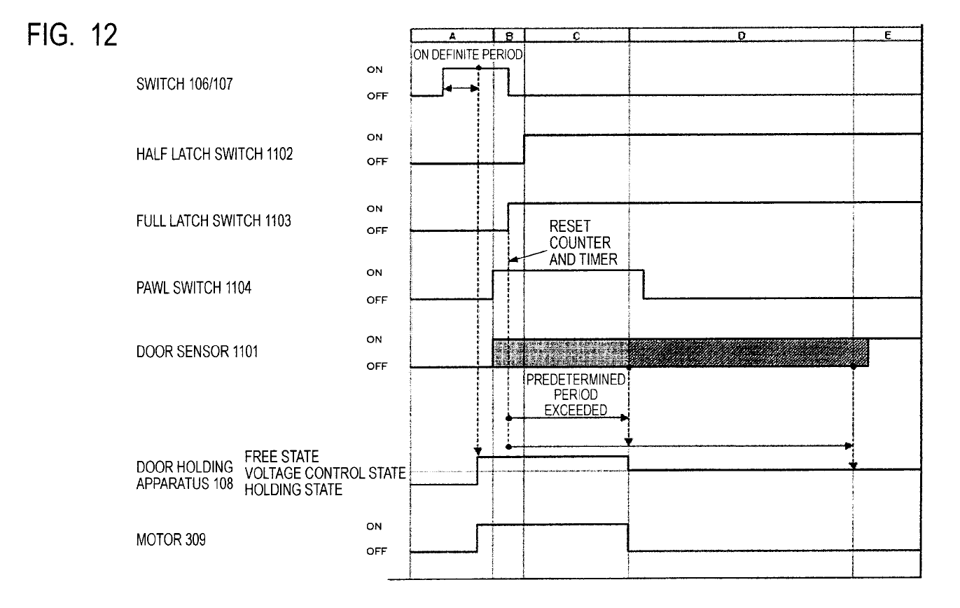

FIG. 12 is an operation chart of the vehicle door drive apparatus 1100 when the side door 101 in the fully closed state is opened according to this embodiment. Moreover, FIG. 13 is a flowchart for illustrating a processing sequence of the pop-up open operation according to this embodiment. The processing sequence is processing executed by the CPU 302 of the control apparatus 301. Thus, the control of the processing is carried out by the CPU 302 reading a program for carrying out the processing illustrated in FIG. 13, which is stored in the ROM 303, and executing the program. In FIG. 12, a region A represents the fully closed state of the side door 101, a region B represents the door ajar state of the side door 101, and a region C represents the pop-up open operation state of the side door 101. Moreover, a region D represents a state (normal state) in which the side door 101 can be manually opened/closed, and a region E represents the fully open state of the side door 101.

Note that, when, regardless of the input location and the input method, the pop-up command is input, the pop-up open operation is to be carried out at a constant pop-up opening degree.

In Step S131, the control apparatus 301 determines whether or not the switch 106 or the switch 107 has been depressed by the user for a sufficient period (ON definite period) for the input of the pop-up command. In other words, the control apparatus 301 determines whether or not the user has depressed the switch for the ON definite period or more based on the pop-up command information input from the switch 106 or the switch 107, and when the control apparatus 301 determines that the user has depressed the switch for the ON definite period or more, the control apparatus 301 proceeds to Step S132. On the other hand, when the depression period of the switch 106 or 107 by the user is less than the ON definite period, until the control apparatus 301 determines that the user has depressed the switch 106 or 107 for the ON definite period or more, the control apparatus 301 repeats Step S131.

In Step S132, the control apparatus 301 switches the door holding apparatus 108 in the holding state to the free state, and simultaneously controls the drive circuit 308 so as to start the drive of the motor 309 for the pop-up open operation. In other words, the control apparatus 301 controls the drive circuit 307 so as to stop the current supply to the electromagnetic brake 204 to which the current is supplied to generate the maximum holding torque, so as to bring the electromagnetic brake 204 into the free state. Simultaneously, the control apparatus 301 drives the motor 309 so as to carry out the pop-up open operation to the set pop-up opening degree θ. On this occasion, the motor 309 is in the driving state, but the side door 101 has not started the automatic movement yet because of the action of the latch apparatus 109. Moreover, the control apparatus 301 controls the drive circuit 306 to drive the latch 109, to thereby rotate the latch positioned in the full latch position.

As illustrated in FIG. 12, when the door holding apparatus 108 is brought into the free state, and the motor 309 is turned on, the pawl switch 1104 is turned on as a result of the drive of the latch, and the door sensor 1101 is also turned on. The turning on of the pawl switch 1104 represents the transition of the fully closed state A to the door ajar state B. Note that, the door sensor 1101 transmits the pulse signal to the control apparatus 301 depending on the movement of the side door 101. The control apparatus 301 accumulates the number of pulses in the RAM 304 based on the pulse signal received from the door sensor 1101. Thus, the RAM 304 functions as a counter for the number of pulses to be used to calculate the angle of the side door 101. The control apparatus 301 can calculate the angle of the side door 101 based on the number of pulses accumulated in the counter.

Note that, according to this embodiment, the control of bringing the electromagnetic brake 204 into the free state and the start of the drive of the motor 309 are carried out simultaneously, but the configuration is not limited to this case. What is important in this embodiment is to bring the electromagnetic brake 204 into the free state before the side door 101 is actually automatically moved by the pop-up open operation. Thus, in FIG. 12, it is only required that before the transition to the pop-up open operation region C, the electromagnetic brake 204 be brought into the free state. As long as this configuration is realized, the transition of the electromagnetic brake 204 (door holding apparatus 108) to the free state, and the turning on of the motor 309 may be at different timings.

In Step S133, as illustrated in FIG. 12, when the full latch switch 1103 is turned on by the rotation of the latch after the door ajar state is brought about, the control apparatus 301 resets the counter and the timer 1105. Considered in an opposite way, the control apparatus 301 starts the counting by using the timer 1105, and also starts the detection of the angle of the side door 101.

As illustrated in FIG. 12, in the door ajar state B, when the half switch 1102 is turned on by the rotation of the latch, under a state in which a bar of the latch apparatus 109 is released, the latch is positioned on the open side with respect to the half latch position, and the door ajar state B thus transitions to the pop-up open operation state C. The motor 309 configured to move the rack 202 (side door 101) has already been in the driving state, and the side door 101 thus automatically starts to move. On this occasion, the electromagnetic brake 204 is in the free state, and the holding mechanism of the side door 101 is in the released state. Thus, the pop-up open operation can be carried out under the state in which the holding force for holding the side door 101 is not generated. In response to the pop-up open operation of the side door 101, the door sensor 1101 transmits the pulse signal to the control apparatus 301. When the control apparatus 301 receives the pulse signal from the door sensor 1101, the control apparatus 301 increments the count of the number of pulses on the counter constructed by the RAM 304. Moreover, the timer 1105 measures the elapsed period during the pop-up open operation.

In Step S134, the control apparatus 301 determines whether or not the current opening degree of the side door 101 has reached the pop-up opening degree θ. In other words, the control apparatus 301 calculates the opening degree of the current side door 101 based on the total number of pulses accumulated on the counter, which is transmitted from the door sensor 1101, and compares the current opening degree with the set pop-up opening degree θ. When the calculated current opening degree is less than the set pop-up opening degree θ, the control apparatus 301 determines that the side door 101 has not reached the pop-up door position yet, and repeats Step S135. On the other hand, when the calculated current opening degree matches the set pop-up opening degree θ, the control apparatus 301 determines that the side door 101 has reached the pop-up door position, and proceeds to Step S136.

In Step S135, the control apparatus 301 refers to the timer 1105, and determines whether or not the elapsed period exceeds the predetermined period. When the elapsed period does not exceed the predetermined period, the control apparatus 301 returns to Step S134. On the other hand, when the elapsed period exceeds the predetermined period, the control apparatus 301 proceeds to Step S136.

In Step S135, the control apparatus 301 controls the drive circuit 308 to stop the drive of the motor 309, thereby stopping the pop-up open operation, and switches the electromagnetic brake 204 from the free state to the voltage control state. Specifically, when the motor 309 stops, the control apparatus 301 determines, based on the pulse signal from the door sensor 1101, whether or not the side door 101 is currently moving. When the control apparatus 301 determines, based on the detection result of the door sensor 1101, that the side door 101 is stopped, the control apparatus 301 controls the drive circuit 307 to drive the electromagnetic brake 204, thereby generating the predetermined holding force. As a result, the electromagnetic brake 204 is brought into the holding state, and the side door 101 is held at the pop-up door position by the above-mentioned holding force.

On the other hand, as a result of the detection of the door sensor 1101, when the control apparatus 301 determines that the side door 101 is moving even after the pop-up open operation has been finished, the control apparatus 301 causes the electromagnetic brake 204 not to generate the holding force, but to maintain the free state. As a result, even immediately after the pop-up open operation is finished, the side door 101 is not held at the pop-up door position, and can continue to move. As an example of the case where the free state is continued immediately after the pop-up open operation is finished as described above, there may be given a case where the user manually opens the side door 101 in addition to the open operation of the side door 101 by the drive of the motor 309 during the pop-up open operation. In this case, the side door 101 is automatically opened by the drive of the motor 309, but an operation force relating to the manual open operation of the side door 101 is also applied. Thus, even when the pop-up open operation is finished, the side door 101 is moving by the manual operation force.

According to this embodiment, in order to determine whether or not the side door 101 is moving after the pop-up open operation is finished, the door sensor 1101 is used. When the side door 101 is opening, the door sensor 1101 transmits the pulse to the control apparatus 301. On the other hand, when the side door 101 is stopped, the door sensor 1101 does not transmit the pulse to the control apparatus 301. In other words, focusing on the pulse transmitted from the door sensor 1101 to the control apparatus 301, when the pulse is output, it is represented that the side door 101 is moving, and when the pulse is not output, it is represented that the side door 101 is stopped. Thus, according to this embodiment, the control apparatus 301 determines whether or not the pulse is received from the door sensor 1101 in the voltage control state after the pop-up open operation is finished so as to determine whether or not the side door 101 is moving. In other words, in the voltage control state, when the pulse is output from the door sensor 1101, the control apparatus 301 determines that the side door 101 is moving, and controls the door holding apparatus 108 so as to bring about the free state. Moreover, in the voltage control state, when the pulse is not output from the door sensor 1101, the control apparatus 301 determines that the side door 101 is stopped, and controls the door holding apparatus 108 so as to bring about the holding state. In this way, the door sensor 1101 has the function of detecting the opening degree of the side door 101 and the function of detecting whether or not the side door 101 is moving.

In this way, the pop-up open operation according to this embodiment is finished. As illustrated in FIG. 12, after the pop-up open operation is finished, the state usually transitions to the normal state D. In the normal state D, the door holding apparatus 08 is in the voltage control state. Thus, in the normal state D, when it is determined that the side door 101 is moving by means of the door sensor 1101, the control apparatus 301 controls the door holding apparatus 108 (electromagnetic brake 204) so as to bring about the free state. Moreover, in the normal state D, when it is determined that the side door 101 is stopped by means of the door sensor 1101, the control apparatus 301 controls the door holding apparatus 108 (electromagnetic brake 204) so as to bring about the holding state. Thus, for example, in a case where the side door 101 is stopped at the pop-up door position after the pop-up open operation is finished, when the user manually carries out the open operation on the side door 101, and when the movement of the side door 101 by the user is detected by the door sensor 1101, the holding force applied by the door holding apparatus 108 is released, and the state transitions to the free state. Moreover, in the state D, in a case where the side door 101 is moving by the manual open operation, when the user stops the side door by intention, and when the stop is detected by the door sensor 1101, the state transitions from the free state to the holding state, and the door holding apparatus 108 holds the side door 101 at the current position.

According to this embodiment, when the pop-up command is input by the user, before the side door 101 becomes movable, the door holding apparatus 108 is forcibly changed from the holding state to the free state. Thus, when the side door 101 is actually automatically opened by the pop-up open operation, the holding force (holding torque) for holding the side door 101 can be prevented from being generated. Thus, the pop-up open operation can smoothly be carried out.

Moreover, when the pop-up open operation is finished, the door holding apparatus 108 can be brought into the voltage control state, and hence whether or not to generate the holding force for the side door 101 can be appropriately selected depending on the movement of the side door 101 when the pop-up open operation is finished. Moreover, also after the pop-up open operation is finished, the door holding apparatus 108 is brought into the voltage control state. Thus, when the side door 101 is manually opened, and the user stops the movement of the side door 101, the side door 101 can be held at the current position by the holding torque of the door holding apparatus 108. Moreover, when the side door 101 is stopped at a predetermined position between the pop-up door position and the fully open state, and the user moves the side door 101 held by the holding force at the current position, the holding force can automatically be released. Thus, the user can manually operate the side door 101 without feeling stress caused by the holding force. In this way, although being basically manual, the open operation of the side door 101 from the fully closed state can be significantly increased.

Incidentally, even when the side door 101 is in the fully closed state, and the pop-up open operation is not carried out, unintended pulses may be output from the door sensor 1101 to the control apparatus 301 by vibrations or the like of the vehicle 100. When the unintended pulses exist, and the side door 101 is not actually carrying out the pop-up open operation, the counter accumulates the count for calculating the opening degree, and the calculated opening degree is deviated from the actual opening degree. However, according to this embodiment, in Step S133, in the pop-up open operation, before the side door 101 starts to open from the fully closed state, the counter accumulating the number of pulses from the door sensor 1101 is reset. Thus, when the side door 101 is in the fully closed state, and even when an unintended output from the door sensor 1101 is generated by the vibrations or the like of the vehicle 100, the unintended pulses can be removed, and the number of pulses relating to the movement of the side door 101 relating to the pop-up open operation can be extracted. Thus, the accuracy of the opening degree calculated based on the detection result by the door sensor 1101 can be increased. In other words, the opening degree when the pop-up open operation is finished can be the set pop-up opening degree θ.

Moreover, according to this embodiment, the elapsed period of the pop-up open operation is measured by the timer 1105, and when the elapsed period exceeds a predetermined period, the control apparatus 301 forcibly proceeds to Step S136, finishes the pop-up operation, and transitions to the voltage control state. Thus, even when the control apparatus 301 recognizes that the state is in the pop-up open operation while the state is not actually in the pop-up open operation, the door holding apparatus 108 can be changed from the free state to the holding state. For example, when a vehicle is in a low temperature environment, and the weather strip is frozen to adhere to the side door 101, while the motor 309 is in the driving state, the side door 101 may not move due to the frozen state. In this case, the control apparatus 301 is executing an algorithm for carrying out the pop-up open operation as a result of the input of the pop-up command, and thus controls the door holding apparatus 108 to be in the free state until the detection result of the door sensor 1101 represents that the opening degree of the side door 101 reaches the set pop-up opening degree θ. On this occasion, the side door 101 is in the state in which the side door 101 is not held by the holding force of the door holding apparatus 108. When the frozen state is cancelled, and the adhesion of the weather strip is released under this state, the side door 101 is not held by the holding force but is in the free state, and hence the side door 101 may open when the user does not intend to open.

In contrast, according to this embodiment, when the side door 101 does not reach the set pop-up opening degree θ even after a certain period has elapsed, the door holding apparatus 108 is forcibly brought into the voltage control state. When the side door 101 is not moving due to the freezing, the side door 101 is in the stopped state when the state transitions to the voltage control state, and the control apparatus 301 thus controls the door holding apparatus 108 to be in the holding state. Thus, the side door 101 is held by the holding force of the door holding apparatus 108. Therefore, even when the frozen state is cancelled, and the adhesion of the weather strip is released, the side door 101 does not freely move, and is held at the current position. Therefore, the side door 101 is prevented from unintentionally being moved.

### Fifth Embodiment

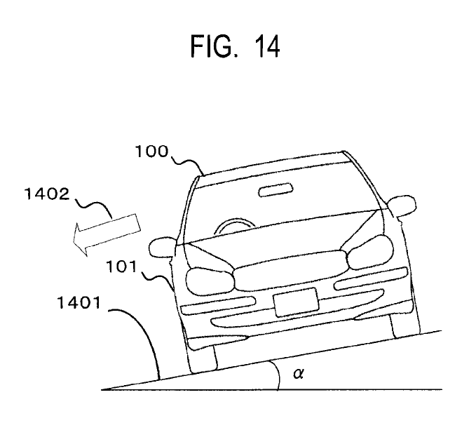

In this embodiment, the holding force of the door holding apparatus 108 is variable depending on the inclination of the vehicle 100. As illustrated in FIG. 14, in the vehicle 100 inclined on a slope 1401 having an inclination angle of a so that the door open direction is oriented toward a lower side of the slope 1401, when the user manually operates the side door 101 to open the side door 101 toward a direction 1402, the side door 101 tends to open by the self-weight. In other words, when the vehicle 100 is inclined as illustrated in FIG. 14, the door open direction of the side door 101 is oriented toward a gravity direction side, and hence the side door 101 tends to open by itself by the self-weight. Thus, an operation force load is generated on the user to suppress this door behavior due to the self-weight.

Thus, according to this embodiment, when the vehicle 100 is inclined so that the side door 101 tends to open by the self-weight toward the door open direction side of the side door 101, the holding force is generated by the door holding apparatus 108 so that the side door 101 is moved by dragging against the holding force. Thus, influence of the weight of the side door 101 generated by the inclination can be cancelled or decreased by the holding force, and the operation force upon opening the side door 101 from the inside of the inclined vehicle 100 can thus be decreased.

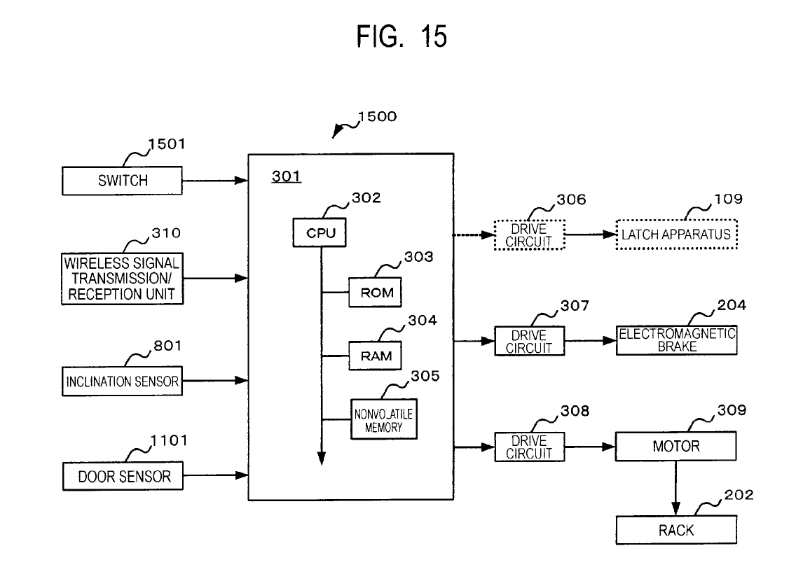

FIG. 15 is a block diagram for illustrating a schematic configuration of a control system in a vehicle door drive apparatus 1500 according to this embodiment.

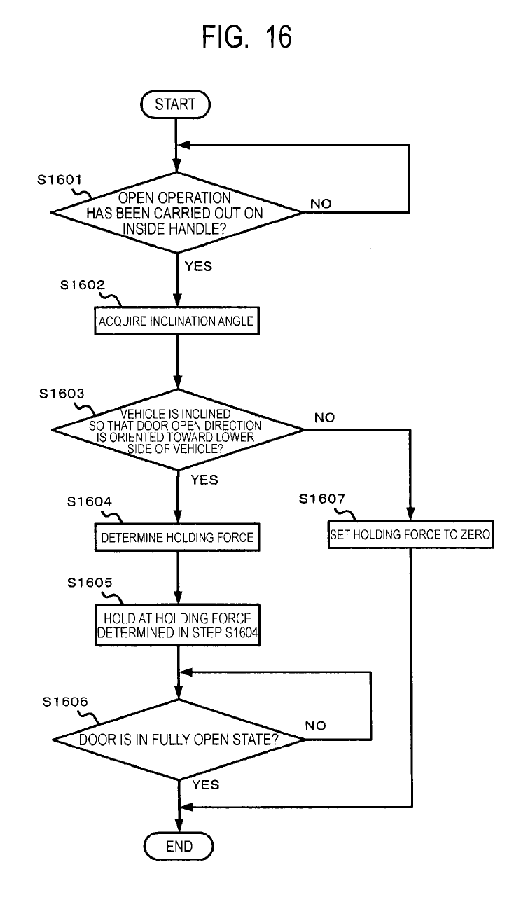

The vehicle door drive apparatus 1500 includes a switch 1501 configured to be activated in association with the inside handle 105, the door holding apparatus 108, the drive circuit 307, the motor 309, the drive circuit 308, the wireless signal transmission/reception unit 310, the inclination sensor 801 configured to detect the inclination angle α of the vehicle 100, the door sensor 1101 configured to measure the opening degree of the side door 101, and the control apparatus 301. Note that, in this embodiment, a control program illustrated in FIG. 16 is stored in the ROM 303.

The switch 1501 is provided on the inside handle 105, and is configured to detect a manual open operation by the user on the inside handle 105, to thereby transmit, to the control apparatus 301, open operation command information representing that the inside handle 105 is pulled by the user to carry out the manual open operation. For example, the switch 1501 is configured to be activated when the inside handle 105 is pulled by a predetermined amount.

FIG. 16 is a flowchart for illustrating a processing sequence of changing the holding force depending on the inclination of the vehicle when the side door is opened from the inside of the vehicle according to this embodiment. The processing sequence is processing executed by the CPU 302 of the control apparatus 301. Thus, the control of the processing is carried out by the CPU 302 reading a program for carrying out the processing illustrated in FIG. 16, which is stored in the ROM 303, and executing the program.

In Step S1601, the control apparatus 301 determines whether or not the open operation command is input by the user via the inside handle 105. When the user manually operates the inside handle 105 to carry out the open operation, the switch 1501 detects the open operation by the user on the inside handle 105, and transmits the open operation command information to the control apparatus 301. When the control apparatus 301 receives the open operation command information from the switch 1501, the control apparatus 301 determines that the open operation has been carried out by the user on the inside handle 105, and proceeds to Step S1602. On the other hand, when the control apparatus 301 does not receive the open operation command information, the control apparatus 301 repeats Step S1601 until the open operation command information is received.

In Step S1602, the control apparatus 301 acquires the inclination angle information from the inclination sensor 801, and acquires the inclination angle α in the door open direction of the side door 101 of the vehicle 100.

In Step S1603, the control apparatus 301 determines whether or not the vehicle 100 is inclined so that the door open direction of the side door 101 serving as an operation object is oriented toward the lower side of the vehicle 100, based on the inclination angle α acquired in Step S1602. In other words, it is determined whether or not the vehicle 100 is inclined so that the side door 101 opens by the self-weight in the door open direction. According to this embodiment, as illustrated in FIG. 14, the inclination angle α is defined so that the inclination angle when the side door 101 is oriented toward a descending side of the slope 1401 is an acute angle. Thus, when the inclination angle α acquired in Step S1602 satisfies 0°<inclination angle α<90°, the control apparatus 301 determines that the vehicle 100 is inclined so that the door open direction of the side door 101 is oriented toward the lower side of the vehicle 100, and proceeds to Step S1604. On the other hand, when the inclination angle α acquired in Step S1602 satisfies 90°<inclination angle α<180°, the control apparatus 301 determines that the vehicle 100 is not inclined so that the door open direction of the side door 101 is oriented toward the lower side of the vehicle 100, and proceeds to Step S1606. Note that, when the inclination angle α acquired in Step S1602 is 0° or 180°, the control apparatus 301 also determines that the vehicle 100 is not inclined so that the door open direction of the side door 101 is oriented toward the lower side of the vehicle 100, and proceeds to Step S1606.

In this way, the inclination sensor 801 can detect the inclination angle α of the vehicle 100, and can detect whether or not the vehicle 100 is inclined so that the door open direction of the side door 101 is oriented toward the lower side of the vehicle 100.

In Step S1604, the control apparatus 301 determines the holding force (holding torque) to be generated by the door holding apparatus 108 depending on the inclination angle α acquired in Step S1602. When the vehicle 100 is inclined so that the side door 101 opens in the door open direction by the self-weight, and the side door 101 in the fully closed state is opened from the inside, the side door 101 is held by the holding force. As a result, the user opens the side door 101 by dragging against the holding force. Thus, in the case of the inclination, an unintended run of the side door 101 can be reduced.

Particularly, according to this embodiment, when the vehicle 100 is inclined so that the door open direction of the side door 101 is oriented toward the lower side of the vehicle 100, the holding force is determined so that operation feeling of the user when the side door 105 in the fully closed state is manually opened by using the inside handle 105 is equivalent to the operation feeling when the vehicle 100 is not inclined (horizontal). Thus, even in the inclined case, the user can open the side door 101 in the fully closed state by using the operation force equivalent to that in the horizontal case. According to this embodiment, the holding force of the door holding apparatus 108 (electromagnetic brake 204) is only required to be set so that the force (weight) of the side door 101 for moving toward the outside of the vehicle 100 by the self-weight is cancelled. For example, it is only required that, while considering the weight of the side door 101, the inclination (inclination angle α) of the vehicle 100 and the force for moving the side door 101 toward the outside by the self-weight of the side door 101 (component of the weight in a normal direction to a plane of the side door 101) be made into a function. When the above-mentioned force is cancelled by the holding force generated by the door holding apparatus 108, even when the vehicle 100 is inclined so that the door open direction of the side door 101 is oriented toward the lower side of the vehicle 100, the operation force of the user can be equivalent to that in the horizontal case. Thus, the control apparatus refers to the function, calculates the force corresponding to the inclination angle acquired in Step S1602, and sets the holding force to be realized to the value of the force.

Note that, as long as the reduction of the load (load by the self-weight of the side door 101) applied on the user is considered when the side door 101 is opened from the inside of the vehicle 100 inclined so that the door open direction of the side door 101 is oriented toward the lower side of the vehicle 100, the side door 101 is only required to be held by the predetermined holding force. In this case, when the vehicle 100 is inclined as described above, the side door 101 may be held by a predetermined holding force (which may be a constant force) by the door holding apparatus 108. Alternatively, the inclination angle α and the holding torque by the door holding apparatus 108 may be associated with each other by means of a table so that the holding force increases as the inclination angle α increases. On this occasion, the control apparatus 301 is only required to refer to the table so as to extract the holding force corresponding to the detected inclination angle α.

In Step S1605, the control apparatus 301 controls the drive circuit 307 so as to cause the electromagnetic brake 204 to generate the holding force (holding torque) determined in Step S1604. In other words, the control apparatus 301 supplies a current to the electromagnetic brake so as to generate the holding torque determined in Step S1604. Thus, the door holding apparatus 108 holds the side door 101 in the fully closed state by the appropriate holding force.

In Step S1606, the control apparatus 301 determines whether or not the side door 101 is in the fully open state based on the pulse signal received from the door sensor 1101. In other words, the control apparatus 301 calculates the current opening degree of the side door 101 based on the pulse signal transmitted from the pulse sensor 1101, and compares the current opening degree with a fully open opening degree set as an opening degree in the fully open state of the side door 101. When the control apparatus 301 determines that the side door 101 is in the fully open state based on the comparison, the control apparatus 301 controls the drive circuit 307 to stop the current supply to the electromagnetic brake 204 so as to release the holding torque, and finishes the processing. On the other hand, when the control apparatus 301 determines that the side door 101 is not in the fully open state based on the comparison, the control apparatus 301 determines that the holding (holding for generating the sense of drag) of the side door 101 by the door holding apparatus 108 is still necessary, and while maintaining the holding by the holding force determined in Step S1604, repeats Step S1606.

In Step S1607, the control apparatus 301 controls the drive circuit 307 to control the electromagnetic brake 204 so as not to generate the holding torque. When Step S1607 is executed, the vehicle 100 is not inclined, or is inclined so that the door open direction of the side door 101 is oriented toward the upper side of the vehicle 100. In other words, the side door 101 is estimated not to open in the door open direction by the self-weight. Thus, according to this embodiment, in this case, the door holding apparatus 108 is controlled so as not to generate the holding force for realizing the sense of drag.

According to this embodiment, when the vehicle 100 is inclined so that the side door 101 opens in the door open direction by the self-weight, and the manual open operation is carried out on the side door 101 by the user from the inside of the vehicle 100, the holding force for holding the side door 101 is generated by the door holding apparatus 108. Thus, a brake can be applied to the side door 101 of the vehicle 100 inclined in this way, which moves by itself by the weight applied to the side door 101 itself in the descending direction of the slope 1401. In other words, in the inclined vehicle 100, the opening of the side door 101 by itself by the self-weight in the door open direction can be prevented or reduced.

Moreover, the force of opening the side door 101 by the self-weight in the door open direction is decreased by the holding force, and the opening of the side door 101 at an unintended speed can thus be prevented or reduced. Further, the side door 101 is held by the holding force generated by the door holding apparatus 108, and the sense of drag can thus be generated during the operation of the user, which makes the feeling of the open operation of the side door 101 close to that in the horizontal case.

Moreover, according to this embodiment, the inclination angle of the vehicle 100 is detected, and the holding force to be generated by the door holding apparatus 108 is determined based on the inclination angle so as to cancel the force of opening the side door 101 by the self-weight in the door open direction. Thus, the holding force can be applied so as to cancel the force caused by the inclination, and the feeling of the open operation of the side door 101 can be equivalent to that in the horizontal case.

Note that, according to this embodiment, the holding force for preventing or reducing the unintended run of the side door 101 in the inclined case is generated by the electromagnetic brake 204, but the configuration is not limited to this case. For example, the holding force may be controlled by a damper mechanism using oil. In this case, the damper mechanism is provided so as to control a resistance of a turn of the lever 205 by a damping force of the damper. Then, the damping force is controlled by means of voltage control of an actuator or the like by changing an orifice diameter of the damper mechanism so as to change viscosity. The force (holding force) of holding the lever 205 is controlled by changing the damping force in this way. Note that, a magnetic fluid may be used to control the damping.

This application claims the benefit of priority from Japanese Patent Application No. 2013-140863, filed on Jul. 4, 2013, Japanese Patent Application No. 2013-140864, filed on Jul. 4, 2013, and Japanese Patent Application No. 2013-140865, filed on Jul. 4, 2013, the contents of which are incorporated herein by reference.

### REFERENCE SIGNS LIST

100 vehicle
101 side door
104 inside handle
105 outside handle
106, 107 switch
108 door holding apparatus
202 rack
203 pinion
204 electromagnetic brake
205 lever
300, 800, 1100, 1500 vehicle door drive apparatus
301 control apparatus
307, 308 drive circuit
309 motor
311 pulse sensor
801 inclination sensor
1101 door sensor

1. A vehicle door drive apparatus, comprising:
an input unit configured to input a command for automatically opening a door of a vehicle in a fully closed state by a predetermined amount that does not bring the door to a fully open state;
a door drive unit configured to automatically open the door;
a determination unit configured to determine, when the command is input by the input unit, the predetermined amount depending on a state of a user or a state of the vehicle; and
an open operation unit configured to control the door drive unit so as to automatically open the door by the determined predetermined amount from the fully closed state.

2. The vehicle door drive apparatus according to claim 1, further comprising a door holding unit configured to generate a holding force for holding the door to hold the door by the holding force.

3. The vehicle door drive apparatus according to claim 2, further comprising a control unit configured to control generation of the holding force of the door holding unit, and to control, before the door actually starts to move in accordance with the command, the door holding unit so as to enter a state of avoiding the generation of the holding force.

4. The vehicle door drive apparatus according to claim 2, further comprising:
a detection unit configured to detect whether or not the vehicle is inclined so that an open direction of the door serving as an operation object is oriented toward a lower side of the vehicle; and
a holding force generation unit configured to control the door holding unit to generate the holding force when the detection unit detects that the vehicle is inclined so that the open direction of the door is oriented toward the lower side of the vehicle.

5. The vehicle door drive apparatus according to claim 1, wherein:
the input unit comprises:
a first input unit provided on the door on an outer side of the vehicle; and
a second input unit provided on the door on an inner side of the vehicle;
the state of the user comprises whether the command is input on the first input unit or input on the second input unit; and
the determination unit is configured to change the predetermined amount between a case in which the command is input on the first input unit and a case in which the command is input on the second input unit.

6. The vehicle door drive apparatus according to claim 5, wherein the predetermined amount when the command is input on the second input unit is more than the predetermined amount when the command is input on the first input unit.

7. A vehicle door drive apparatus, comprising:
an input unit configured to input a command for automatically opening a door of a vehicle in a fully closed state by a predetermined amount that does not bring the door to a fully open state;
a door drive unit configured to automatically open the door;
a door holding unit configured to generate a holding force for holding the door to hold the door by the holding force;
an open operation unit configured to control, based on the command, the door drive unit so as to automatically open the door by the predetermined amount; and
a control unit configured to control generation of the holding force of the door holding unit, and to control, before the door actually starts to move in accordance with the command, the door holding unit so as to enter a state of avoiding the generation of the holding force.

8. The vehicle door drive apparatus according to claim 7, wherein, after the door is automatically opened by the predetermined amount, when the door is moving, the control unit controls the door holding unit so as to enter the state of avoiding the generation of the holding force, and when the door is not moving, the control unit controls the door holding unit so as to enter a state of generating the holding force.

9. The vehicle door drive apparatus according to claim 8, further comprising a detection unit configured to detect whether or not the door is moving,
wherein, after the door is automatically opened by the predetermined amount, when the detection unit detects that the door is moving, the control unit controls the door holding unit so as to enter the state of avoiding the generation of the holding force, and when the detection unit detects that the door is not moving, the control unit controls the door holding unit so as to enter the state of generating the holding force.

10. The vehicle door drive apparatus according to claim 9, wherein:
the detection unit comprises a sensor configured to have, in addition to a function of detecting whether or not the door is moving, a function of detecting an opening degree of the door; and
the control unit is configured to:
count a number of pulses output from the sensor, to thereby calculate the opening degree of the door based on the count;
finish, when the calculated opening degree of the door matches an opening degree corresponding to the predetermined amount, an operation of automatically opening the door by the predetermined amount; and
reset the count after the command is input by the input unit and before the door actually starts to move from the fully closed state.

11. The vehicle door drive apparatus according to claim 7, further comprising a measurement unit configured to measure an elapsed period after the operation of automatically opening the door by the predetermined amount is started,
wherein, in a case where the elapsed period exceeds a predetermined period, when the door is moving, the control unit controls the door holding unit so as to enter the state of avoiding the generation of the holding force, and when the door is not moving, the control unit controls the door holding unit so as to enter the state of generating the holding force.

12. (canceled)

13. A vehicle door drive apparatus comprising:
a detection unit configured to detect whether or not a vehicle is inclined so that an open direction of a door of the vehicle, which serves as an operation object, is oriented toward a lower side of the vehicle;
a door holding unit configured to generate a holding force for holding the door to hold the door by the holding force; and
a holding force generation unit configured to control the door holding unit to generate the holding force when the detection unit detects that the vehicle is inclined so that the open direction of the door is oriented toward the lower side of the vehicle,
wherein the detection unit is configured to carry out the detection when a user carries out an open operation on a door handle on an inner side of the vehicle of the door in a fully closed state.

14. The vehicle door drive apparatus according to claim 13, further comprising a determination unit configured to determine the holding force depending on an inclination of the vehicle,
wherein the holding force generation unit is configured to control the door holding unit so as to generate the determined holding force.
